(19) United States
(12) Patent Application Publication
(10) Pub. No.: US 2024/0427942 A1
(43) Pub. Date: Dec. 26, 2024

(54) OBFUSCATING ANALOG CIRCUITS USING SWITCHED PHASE CIRCUITS

(71) Applicant: Northeastern University, Boston, MA (US)

(72) Inventor: Aatmesh Shrivastava, Weston, MA (US)

(21) Appl. No.: 18/744,204

(22) Filed: Jun. 14, 2024

Related U.S. Application Data
(60) Provisional application No. 63/522,029, filed on Jun. 20, 2023.

(51) Int. Cl. G06F 21/70

(52) U.S. Cl. CPC G06F 21/70

(57) ABSTRACT

Methods, systems, and computer program products are presented herein for obfuscating analog circuits using switched phase circuits. In particular, methods, systems, and computer program products using a Switch Mode Time Domain Locking (SMDL) scheme, presented herein, may be used to protect analog circuits. A first input signal to an analog circuit is generated. The first input signal comprises a reference phase. The analog circuit is adapted to perform a predetermined function. A second input signal to the analog circuit is generated. The second input signal comprises a provided phase. Enablement of the predetermined function of the analog circuit is toggled based on alignment of the reference phase and the provided phase.

### CROSS REFERENCE TO RELATED APPLICATIONS

This application claims priority from U.S. Provisional Patent Application No. 63/522,029 filed on Jun. 20, 2023, which is hereby incorporated by reference herein in its entirety.

### BACKGROUND

### Field of the Disclosed Subject Matter

The disclosed subject matter relates to analog circuits using switched phase circuits. Particularly, the present disclosed subject matter is directed to obfuscation of the functionality of such circuits using securing mechanisms and related techniques.

### Description of Related Art

Chip design, which used to be largely an in-house design activity of system and microelectronics companies, has now transformed in to a supply-chain based process where design involves integration of third-party IPs and manufacturing is outsourced to a handful of foundries. Under the new horizontal business model for the hardware design, microelectronics design companies are relying on untrusted foundries, intellectual property (IP) providers, and shared training models that render their designs vulnerable to different types of adversarial attacks. Under such a horizontal business model, fab-less microelectronics companies are particularly vulnerable to all sorts of adversarial attacks.

As more and more integrated circuit (IC) designs are sourced externally, concerns about design reliability and security have increased. Third-party foundries could potentially steal intellectual property (IP) [1], counterfeit or overproduce ICs [2], [3], or insert layout Trojans [4]-[6]. These hardware attack modalities have targeted both digital and analog IPs. Large semiconductor companies, primarily focused on digital computing infrastructure, dominated the industry over last decades. Consequently, research has predominantly centered on techniques to protect digital IPs, including encryption [7] and logic-locking [8]-[10]. However, analog hardware is expected to dominate the future growth of semiconductors due to its application in future technologies such as artificial intelligence (AI), autonomous driving, 6G, and the internet-of-things (IoT) [11].

Several examples of IP thefts, counterfeiting, overproduction of analog ICs exist in the literature. However, only limited research exist for locking analog IPs [12]-[16]. In addition, only limited research related to obfuscation techniques exist for analog ICs. Analog circuits are also easily identifiable in layout due to unique characteristics such as variety of components and sizes, symmetry in design, use of dummy devices, guard rings, well proximity and matching, and custom layout for performance optimization, which may make the locking and/or obfuscation techniques easily identifiable. Thus, there is a need to develop comprehensive analog IP locking techniques.

This necessity arises not only due to the projected growth of analog hardware but also because analog circuits consistently undertake critical tasks, even within predominantly digital ICs. The effort to protect analog design is in its early evolving stage. Some of the techniques that have been presented in the literature include vector-based parameter obfuscation [12], split-manufacturing [13], and camouflaging [14] among others. These analog locking strategies have limited scope and lack the completeness provided by conventional encryption schemes. A key difference between analog and digital locking techniques lies in the strength of protection strategies. In digital implementation, large key size with high entropy can be incorporated but same is not possible with analog implementations. In particular, under conventional approaches, large key size cannot be used to protect analog ICs because of the design overhead and performance implications. Additionally, these approaches impact analog circuit functionality by reducing performance and incurring significant area overhead. They can also suffer from the issue of multiple correct keys for unlocking the desired analog functionality.

Several approaches have been proposed to prevent adversarial attacks in analog ICs. However, these mitigation strategies have limited scope and lack the completeness that a conventional digital locking scheme provides. Additionally, these approaches impact analog IC functionality by reducing their performance and incurring large area overhead. They can also suffer from the issue of multiple correct keys. Therefore, there is a need to detect and prevent adversarial attacks in analog ICs, while providing protection from a broad scope of attacks, the completeness that a conventional digital locking scheme provides, and minimal impact on analog IC functionality.

### SUMMARY OF THE DISCLOSED SUBJECT MATTER

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

Fundamental techniques and systems to lock analog circuits and their functionality using switched capacitor based phase and frequency locking scheme are presented herein. Utilizing switched capacitor behavior, the analog circuit can be locked using an arbitrarily long key. The systems and techniques presented herein may also overcome the issue of having “multiple correct keys”. Further, the proposed approach may include an insignificant performance overhead retaining the key analog circuit functionality.

In particular, an analog circuit locking scheme is presented herein. In this scheme large key space functions, such as physically unclonable functions (PUF), can be used for locking the analog circuit. The approach may use a switched capacitor and switching circuits.

To achieve these and other advantages and in accordance with the purpose of the disclosed subject matter, as embodied and broadly described, the disclosed subject matter includes a method for obfuscating analog switched phase circuits. A first input signal to an analog circuit is generated. The first input signal comprises a reference phase. The analog circuit is adapted to perform a predetermined function. A second input signal to the analog circuit is generated. The second input signal comprises a provided phase. Enablement of the predetermined function of the analog circuit is toggled based on alignment of the reference phase and the provided phase.

Generating the first input signal may comprise generating the first input signal by applying an output of a key space function to a clock signal. The key space function may be a physically unclonable function (PUF). The output of the key space function may be a first key. The first input signal may be output from a shift register adapted to receive the clock signal and the output of the key space function. Generating the second input signal may comprise generating the second input signal by applying a second key to a clock signal. The second input signal may be output from a shift register adapted to receive the clock signal and the second key. The second key may be a user input key. Toggling the enablement of the predetermined function of the analog circuit may comprise disabling the predetermined function of the analog circuit when the reference phase and the provided phase are misaligned. Disabling the predetermined function may comprise producing a short-circuit or an open-circuit in the analog circuit. The short-circuit or the open-circuit may be sensed in the analog circuit. An occurrence of an adversarial attack may be determined based on the short-circuit or the open-circuit. Toggling the enablement of the predetermined function of the analog circuit may comprise enabling the predetermined function of the analog circuit when the reference phase and the provided phase are aligned.

The disclosed subject matter also includes a system for obfuscating analog switched phase circuits. The system comprises a key space function circuit/unit, a key loading unit, a first shift register, and a second shift register. The key space function circuit is adapted to generate a first key. The key loading unit is adapted to receive a second key. The first shift register is adapted to receive a clock signal, receive the first key from the key space function circuit, and apply the first key to the clock signal to generate a first input signal to an analog circuit. The first input signal comprises a reference phase. The analog circuit is adapted to perform a predetermined function. The second shift register is adapted to receive the clock signal, receive the second key from the key loading unit, and apply the second key to the clock signal generate a second input signal to the analog circuit. The second input signal comprises a provided phase. Enablement of the predetermined function of the analog circuit is toggled based on alignment of the reference phase and the provided phase.

The key space function circuit may be a physically unclonable function (PUF) circuit. The second key may be a user input key. The ability of the analog circuit to perform the predetermined function may be disabled when the reference phase and the provided phase are misaligned. The predetermined function of the analog circuit may be disabled by producing a short-circuit or an open-circuit in the analog circuit. The system may further comprising sensor circuitry adapted to sense the short-circuit or the open-circuit in the analog circuit, and determine an occurrence of an adversarial attack based on the short-circuit or the open-circuit. The predetermined function of the analog circuit may be enabled when the reference phase and the provided phase are aligned. The analog circuit may comprise a chopping amplifier, a switched-capacitor voltage regulator, a bandgap voltage reference circuit, or a DC-DC converter.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present subject matter and may illustrate one or more embodiment(s) or example(s) of the present subject matter in whole or in part.

FIGS. 1A-1D depict a design and an application of analog circuits according to various embodiments of the present disclosure. In particular, FIG. 1A depicts a circuit with bias current locking. FIG. 1B depicts a diagram of a statistical process distribution of the gain of the amplifier in FIG. 1A. FIG. 1C depicts a use of the amplifier in FIG. 1A in a feedback loop.

FIG. 1D depicts the use of a Low Noise Amplifier (LNA) with an Automatic Gain Control (AGC) loop.

FIGS. 2A-2B depict switched-capacitor based analog circuits utilizing two non-overlapping clocks according to various embodiments of the present disclosure. FIG. 2A shows a switched-capacitor based analog circuit and switching phases of the input signals to the switched-capacitor based analog circuit. FIG. 2B shows a chopping amplifier that uses two phases of a clock, such as the switching phases of the input signals to the switched-capacitor based analog circuit in FIG. 1A.

FIGS. 3A-3C depict the techniques and systems using Switch Mode Time Domain Locking (SMDL) according to various embodiments of the present disclosure. FIG. 3A shows the architecture of a locking circuit for use with an analog circuit and a switching phase based locking technique operating on the locking circuit. FIG. 3B shows two signals that are determined to include a correct key in a high-precision power sensing based adversarial attack detection technique. FIG. 3C shows two signals that are determined to include an incorrect key in a high-precision power sensing based adversarial attack detection technique.

FIG. 4 depicts a fully differential folded cascode amplifier (FCA) with a Common Mode Feedback (CMFB) circuit according to various embodiments of the present disclosure.

FIG. 5 depicts chopping and locking implementation in the folded cascode amplifier (FCA) according to various embodiments of the present disclosure.

FIGS. 6A-6D depict transient simulation results of the FCA in different application cases, where the CK is dacf62b1e301f6e970595af0e4012e23 and the IK is aaaaaaaaaaaaaaaaaaaaaaaaaaaaaaaa according to various embodiments of the present disclosure. In particular, FIG. 6A shows the output of the FCA without chopping. FIG. 6B shows that the output during the simulation achieved a swing of 1 V. FIG. 6C shows the simulation result of a correct key input to the chopper included on the FCA. FIG. 6D shows the simulation result of an incorrect key input to the chopper included on the FCA.

FIGS. 7A-7C depict a switched-capacitor based subtractor BGR circuit according to various embodiments of the present disclosure. In particular, FIG. 7A shows a BJT Biasing and V_{EB} generation circuit. FIG. 7B shows a subtractor circuit. FIG. 7C shows a timing diagram of V_{EB1_HOLD}, V_{EB2_HOLD}, and V_{REF} and different phases.

FIG. 8 depicts the transient simulation result of the switched-cap BGR with incorrect key showing collapse of the voltage according to various embodiments of the present disclosure.

FIG. 9 depicts a block diagram for a random key generator that was used for evaluating the SMDL technique according to various embodiments of the present disclosure.

FIG. 10 depicts an auto-correlation simulation of four randomly selected key sequences to measure the randomness of the keys generated by the key generator according to various embodiments of the present disclosure.

FIGS. 11A-11B depict simulation results of the entropy and the Hamming distance of randomly generated keys according to various embodiments of the present disclosure. In particular, FIG. 11A depicts the entropy of random bits in a PUF Key. FIG. 11B depicts the Hamming distance of random bits in the PUF key.

FIGS. 12A-12B depict the frequency response of the chopper amplifier circuit using an F.C amplifier circuit designed in 65 nm CMOS technology according to various embodiments of the present disclosure. In particular, FIG. 12A depicts the gain of the amplifier.

FIG. 12B depicts the phase response of the amplifier.

FIGS. 13A-13B depict the power spectral density (PSD) plot of a FCA according to various embodiments of the present disclosure. In particular, FIG. 13A shows the PSD of the output signal when a correct key was applied. FIG. 13B shows the PSD of the output signal when an incorrect key was applied.

FIGS. 14A-14B depict the DFT plot of a chopped FCA according to various embodiments of the present disclosure. FIG. 14A shows the DFT plot of the chopped FCA with a correct key applied. FIG. 14B shows the DFT plot of the chopped FCA with an incorrect key applied.

FIGS. 15A-15B depict process variation of gain of an FCA according to various embodiments of the present disclosure. FIG. 15A shows a gain variation histogram with a clock-based chopping FCA. FIG. 15B shows a gain variation histogram with a key-based chopping FCA.

FIGS. 16A-16B depict simulation results of power supply rejection ratio (PSRR) of an FCA according to various embodiments of the present disclosure. FIG. 16A shows the PSRR of a clock-based chopping FCA. FIG. 16B shows the PSRR of a key-based chopping FCA.

FIG. 17 depicts a histogram and normalized distribution of the variation of the gain of an FCA with different keys in key-based chopping according to various embodiments of the present disclosure.

FIG. 18 depicts a temperature variation simulation of a BGR circuit showing 0.2 mV for a 125° C. temperature variation according to various embodiments of the present disclosure.

FIGS. 19A-19B depict process variation of a BGR output voltage according to various embodiments of the present disclosure. FIG. 19A shows the statistical variation of V_{REF} with a clock-based SC BGR. FIG. 19B shows the statistical variation of V_{REF} with a key-based SC BGR.

FIG. 20 depicts a table with a comparison of SMDL with other reported works in the literature across cryptographic properties such as key-size, key-entropy, TK error among others, along with circuit's performance, power, and area overhead according to various embodiments of the present disclosure.

FIG. 21 is a flow chart depicting a method for obfuscating analog circuits using switched phase circuits according to various embodiments of the present disclosure.

### DETAILED DESCRIPTION

Reference will now be made in detail to exemplary embodiments of the disclosed subject matter, an example of which is illustrated in the accompanying drawings. The method and corresponding steps of the disclosed subject matter will be described in conjunction with the detailed description of the system.

Obfuscating analog circuits using switched phase circuits using an analog circuit locking scheme where large key space functions such as physically unclonable functions (PUF) used for locking the analog circuit with switched capacitor and switching circuits may use switched phases of a clock to lock the analog circuit. Obfuscating analog circuits using switched phase circuits may lock the circuit in the time domain. Obfuscating analog circuits using switched phase circuits may lock the circuit with a very long key.

The described subject matter may lock an analog circuit with a long key to the equivalent of digital encryption. The described subject matter may disable analog circuit functionality with an incorrect key. The described subject matter may retain circuit performance with the correct key. The described subject matter may detect when an incorrect key is being applied.

Obfuscating analog circuits using switched phase circuits using an analog circuit locking scheme where large key space functions such as physically unclonable functions (PUF) used for locking the analog circuit with switched capacitor and switching circuits may use switched phases of a clock to lock the analog circuit. Obfuscating analog circuits using switched phase circuits may be utilized in the design of commercial integrated circuits. Obfuscating analog circuits using switched phase circuits may detect the presence of malware in circuits. Obfuscating analog circuits using switched phase circuits may prevent the overproduction and/or theft of analog integrated circuits.

The scheme described herein may use a switching technique in clocks and hence prevent the loading critical circuit blocks improving performance. The described subject matter may provide the ability to purchase verified integrated circuits.

The development of locking analog circuit functionality using PUFs aims to harden hardware security for analog circuits in a similar way as that for digital using more conventional encryption schemes. In various embodiments, a CMOS based mixed-signal encryption and authentication scheme is provided herein for several fundamental analog circuits. In various embodiments, a locking scheme is provided for analog circuits, where the locking scheme can have arbitrarily long keys (>256-bit) while maintaining analog circuit performance. In various embodiments, the method to lock the analog circuit functionality, as presented herein, is low cost, lower area, and easily integrate-able. In various embodiments, a validation method that can detect the presence of adversarial attack through validation and evaluation is presented herein. Comprehensive validation techniques for evaluating the proposed detection circuit and validation methods described herein may be provided for a variety of target IPs and systems.

Analog circuit locking techniques using voltage or current bias may use a binary key to lock the correct bias configuration [12], [17], [18]. However, these methods may suffer from relatively small key sizes due to the lower binary resolution needed to achieve the required bias configuration. Further, analog circuits may not be dependent on a unique bias but rather on a range of voltage or current bias. This may result in multiple correct keys (CK) for the locking technique. Owing to these factors, errors in performance or functionality between an incorrect key (IK) and CK can be as little as 3% [18]. Also, similar bias configurations may be needed for different chips, leading to repeated correct keys for those chips. This technique may lead to lower key entropy. These techniques may additionally incur high performance, area, and power overheads.

Another locking method may use a circuit's calibration bits. Analog circuits may require large calibration space to optimize their performance. Techniques to lock analog circuits by locking calibration bits can achieve a large key space [19], [20] owing to large calibration space in modern IC design. However, the production goal for ICs may still be to target mean performance with large calibration space provided to overcome production related process variations. A very large number of manufactured ICs may achieve mean target performance. This may lead to a very small variation in calibration bits for those ICs. It may eventually result in low key entropy with repeated keys for multiple ICs. As calibration bits control circuit performance, an incorrect calibration may result in suboptimal performance but not necessarily loss of circuit functionality. The least IK error for calibration-based locking has been 27% [19]. Because these methods may be based on calibration, they may not incur large area, power, or performance overheads.

Design-based locking techniques may present multiple transistor options with varying threshold voltage (VTH) [21] or varying layout [22] for same analog function (e.g., current source). Two or more transistors may be used where one transistor will suffice with only the correct transistor choice realizing circuit functionality. All other choices may lead to a wrong circuit operation. As analog circuits require a decent combination of bias, load, and control functionality, a decent sized combination choice for a key can be achieved. However, analog circuits may not be very large and these locking scheme can only provide a small key size. They only may have one correct key which leads to no key entropy. Error due to an incorrect key can be high, more than 92% [21] in this locking scheme as significant variation may be added to the circuit due to a wrong transistor choice. However, adding multiple transistors may add to area overhead of up to 175% and power overhead of 70% [22] for the same circuit performance.

An analog neural network (ANN) based approach may use analog inputs as key to generate circuit's bias condition via a neural network [15]. This technique can generate a large number of keys based on input voltage combination, unique to each chip. However, input bias combination may be limited due to limited operating voltage for transistors which may result in a rather limited key space. Further, voltages closer to the key voltages may also yield correct bias condition leading the design to have multiple correct keys. IKs can only produce 20% error in the output as incorrect bias can still maintain basic circuit functionality. Design can incur high area overhead due to ANN implementation but power overhead may be low.

Presented herein are novel techniques and systems to lock analog circuits and their functionality using a switching capacitor-based phase and frequency locking scheme. The proposed techniques and systems utilize locking analog signals in the time domain instead of in space, i.e., additional design space may be needed for the locking functionality. Utilizing this approach, analog IPs can be locked utilizing large key space functions like physically unclonable functions (PUFs). This approach, which employs locking analog signals in time may enable locking using an arbitrarily long key. The techniques and systems presented herein may overcome the issue of multiple correct keys. Further, the proposed approach may present an insignificant performance overhead retaining the key analog circuit functionality. An overview of threat models for analog circuits is presented herein. Section III covers the implication of locking on analog circuits. The proposed techniques and systems that use a Switched Mode Time Domain Locking (SMDL) scheme are presented. The circuit design and experimental results are also presented herein.

For purpose of explanation and illustration, and not limitation, exemplary embodiments of the system in accordance with the disclosed subject matter are shown in the Figures presented herein. Similar reference numerals (differentiated by the leading numeral) may be provided among the various views and Figures presented herein to denote functionally corresponding, but not necessarily identical structures.

### Threat Model

Several types of supply chain attacks can be launched on analog circuit IPs. These attacks may be dependent on the location of the third party in the supply chain. For example, in a piracy attack [1], an attacker may steal the IP by having access to the layout to use it as their own product. Overproduction may be another common attack where a third party foundry overproduces an analog product and then sells it in the market which cuts into the sale of original manufacturer [3]. A counterfeiting attack may be yet another attack where an older IC is refurbished and sold as a new IC [2]. In a reverse engineering attack, the attacker may use high resolution images of the reverse engineered layout to reproduce the design. Presented herein are techniques and systems that may use long random keys, which can be generated using random variations (e.g., physically unclonable functions (PUFs)), to lock analog circuits using SMDL with an aim to prevent several of these attacks.

### Analog Design Implication on Locking

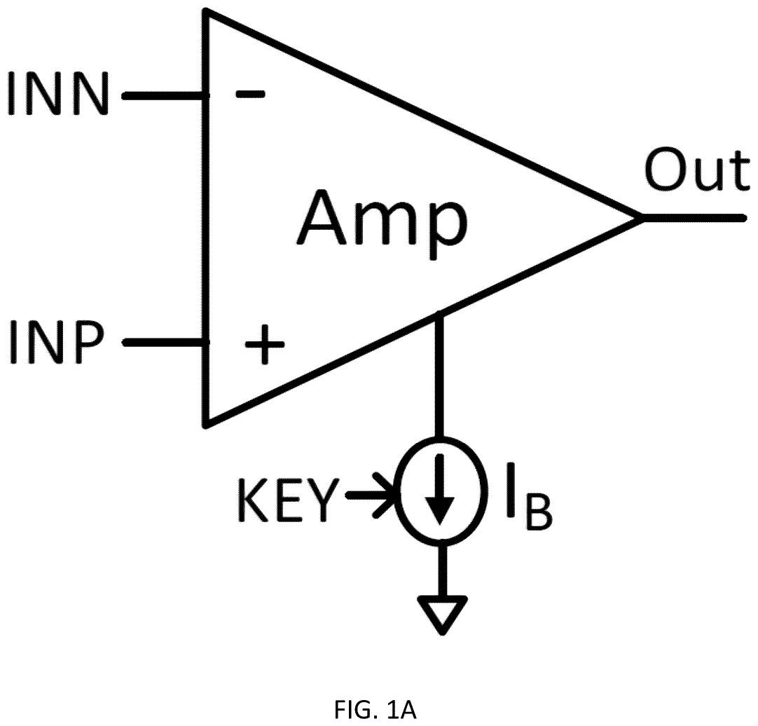

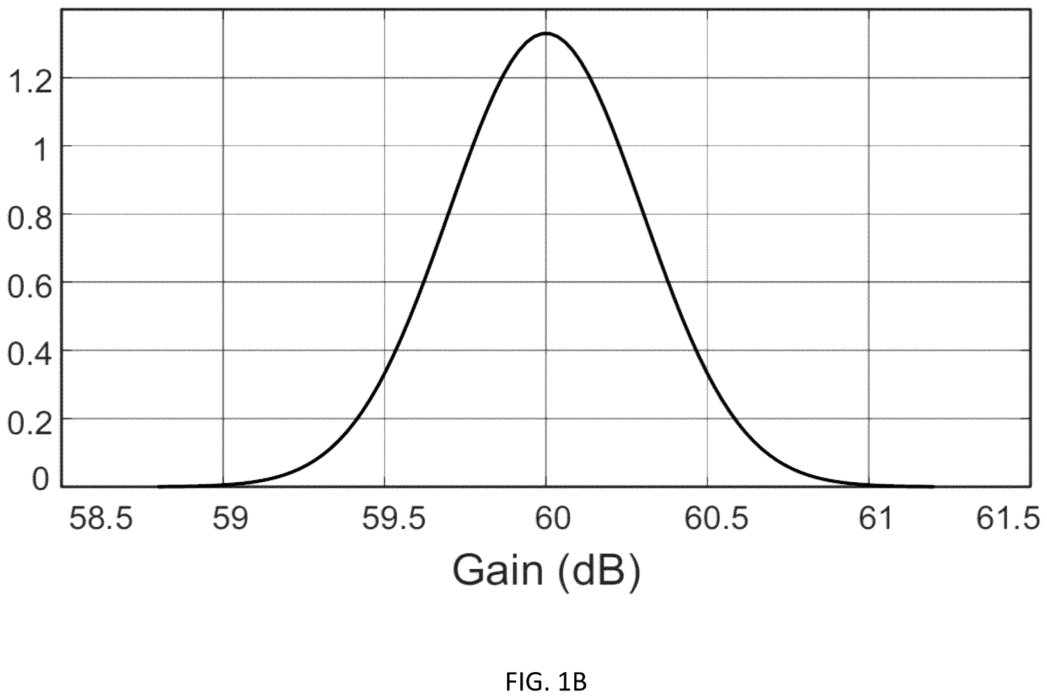

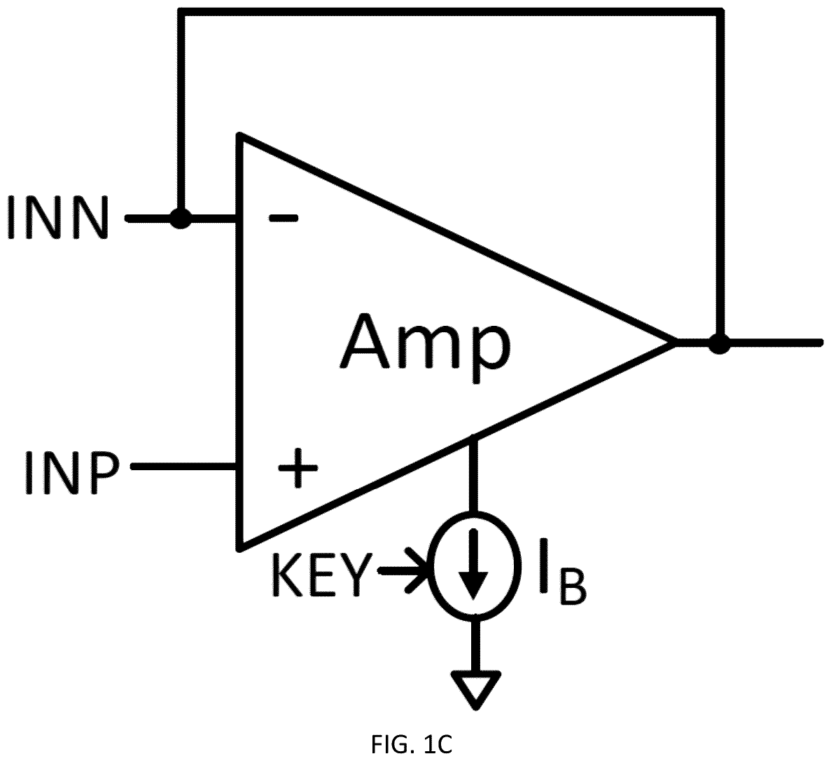

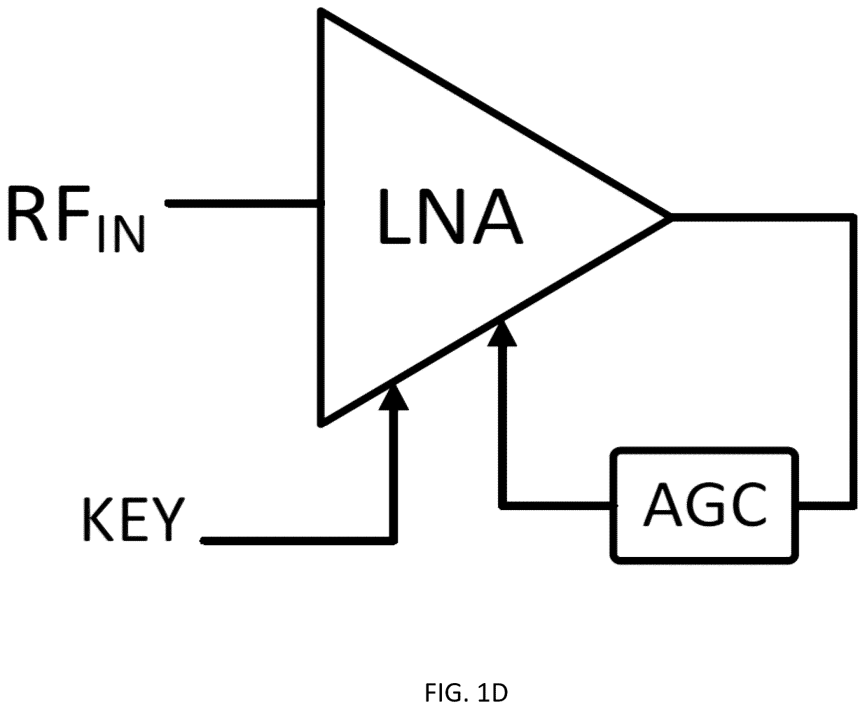

Several design considerations and application scenarios may restrict the effectiveness of conventional locking techniques for analog circuits. FIGS. 1A-1D briefly illustrates this. FIGS. 1A-1D depict design and application of analog circuits according to various embodiments of the present disclosure. FIG. 1A shows the circuit design of a 2-stage operational amplifier (OPAMP) with a key to lock the correct bias current. Proper selection of bias current may play a crucial role in determining the gain and bandwidth (BW) of the amplifier shown in in FIG. 1A. However, a fixed value of gain may not usually be achieved due to process, temperature, and voltage (PTV) variations. FIG. 1B shows the process variation of the gain of the amplifier in FIG. 1A. The amplifier in FIG. 1A has been designed for a mean gain of 60 dB but shows a variation from 59-61 dB. This variation of gain may usually be factored in the overall system design. For a given process corner, different values of bias current can provide gain in the given range. This may lead to the issue of multiple CKs.

The variability issue may further be complicated when analog circuits are used in a feedback loop. FIG. 1C shows the voltage follower configuration of an amplifier commonly used in low-dropout regulators (LDOs), analog drivers, etc. An amplifier with a gain of 60 dB may show an output error of 0.1% (A/(A+1). However an incorrect key that sets the amplifier gain to 57 dB may only see an error of 0.2%. While this error may be slightly higher than in original design, it may have very little effect on system performance. For example, a 0.2% error in an LDO output due to amplifier may be quite acceptable.

Another application scenario is depicted in FIG. 1D with a low-noise amplifier (LNA). The power of an incoming RF signal (RFIN) can have several orders of magnitude variation. This variation, primarily due to the physical distance between the radio transmitter and receiver, may change due to several application factors. The transmitted RF power, which decreases as square law with distance (Near field), can therefore see a large variation. The RF receiver design can cater to this variation. Typically in RF receivers, this maybe handled using a received signal strength indicator (RSSI) [23] and an automatic gain control (AGC) circuit. The RSSI circuit may indicate the power of the incoming RF signal and the AGC may then adjust the gain of LNA to keep the RF at the right level and to avoid distortions in the received signal. A locking key can only restrict the LNA gain so much due to the variation of received RF power and the control feedback from AGC loop to keep LNA linear.

The above examples, as shown in FIGS. 1A-1D, illustrate some of the challenges in effectively locking analog circuits. Conventional techniques have aimed to lock analog circuits in space. However, these approaches may conflict with the functionality of analog circuits which may also dependent on space. As described herein, this issue may be overcome by locking the functionality of analog circuits in time. This technique may be developed by utilizing the fact that the output of an analog circuit may be dependent on time. By combining a key with a clock to run an analog circuit, the key may be made arbitrarily long, thus leveraging a long key which is often necessary to provably secure systems.

The methods, systems, and computer program products, presented herein, may be used for obfuscating analog circuits using switched phase circuits. In particular, techniques systems, and computer program products are presented herein to lock analog circuits and their functionality. The methods, systems, and computer program products may use a switched capacitor based phase and frequency locking scheme are presented herein. The methods, systems, and computer program products, presented herein, may detect and prevent adversarial attacks in analog ICs.

### Switching Mode Time Domain Locking

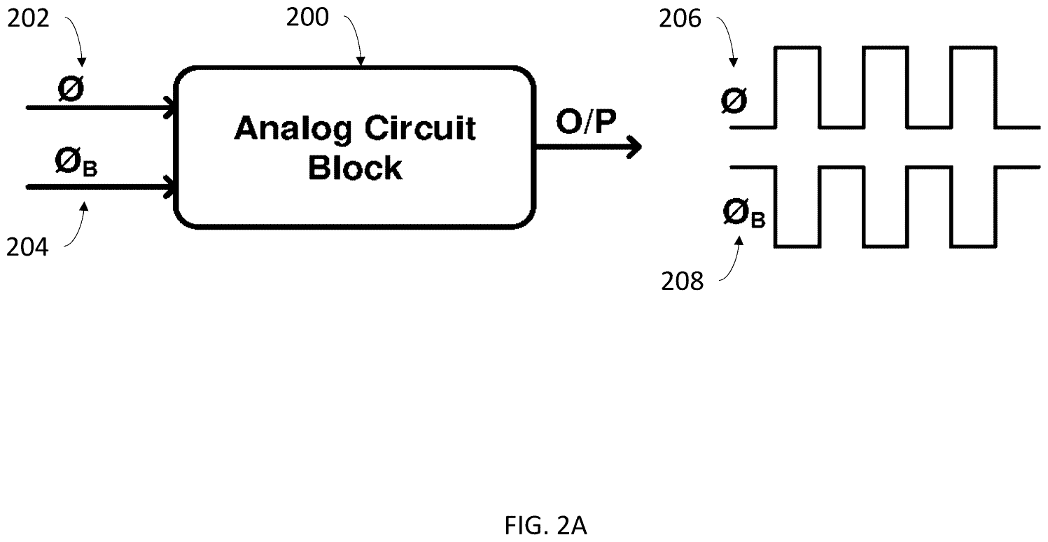

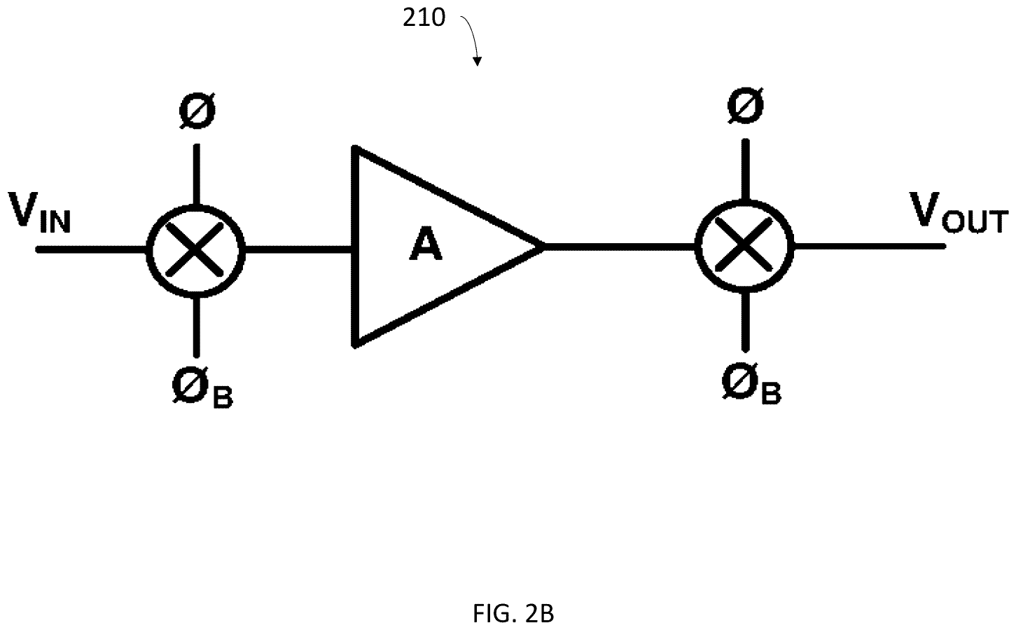

FIG. 2A shows a switched-capacitor based analog circuit 200 and switching phases 206 and 208 of the input signals 202 and 204, respectively, to the switched-capacitor based analog circuit according to various embodiments of the present disclosure. In particular, in accordance with various embodiments, FIG. 2A shows a high-level architecture of an analog circuit 200 utilizing a switching capacitor network for its design. In switched capacitor network based circuits, one or more phases of a clock, such as 206 and 208, may be used to realize variety of analog functionality.

FIG. 2B shows a chopping amplifier 210 that uses two phases of a clock, such as the switching phases 206 and 208 of the input signals 202 and 204, respectively, to the switched-capacitor based analog circuit in FIG. 2A, according to various embodiments of the present disclosure.

In a more conventional analog amplifier design, correlated double sample (CDS) [24] or chopping may be employed in an amplifier, such as amplifier 210, to handle (e.g., attenuate) low-frequency noise and offset of analog amplifier (FIG. 2B). A CDS network may sample the input, generate a modulated output, which may be sampled again to generate a demodulated final output. However, in the CDS network, design offset and low-frequency noise may be modulated only once and therefore are filtered out. Similarly, a switched capacitor network may be used in the design of switched-capacitor based DC-DC converters. In such a DC-DC converter design, capacitors may be used for transferring charge from an input source to an output using one or more phases of a clock. A variety of analog circuits use switching and/or switching-capacitor based networks to improve the design parameters. For example, a low power bandgap voltage reference circuit may use a switched-capacitor network [25].

The analog circuit locking scheme, presented herein, may be based on utilizing encryption potential in a switching circuits. In order for an analog circuit to function properly, the phase and frequency relation between switching phases of clock signals, generated based on input keys, and input to the circuit, may need to be properly aligned. A misalignment of phase or frequency of these switching phases may result in locking of the circuit's functionality, such as by a failure of the circuit. Further, what may be required for the analog circuit to be unlocked and/or its functionality to be normal may be the relative phase and frequency alignment of the switching phases, of the clock signals, to each other. The analog circuit may continue to function normally even if the actual switching frequency of the clock is varied, as long as the relative alignment with the switching phases is maintained. This may mean that a switching clock can be made with random data and that the phases of the clock signals can be used to lock the analog circuit. Only a correct key may unlock the functionality of the analog circuit.

### Locking Technique

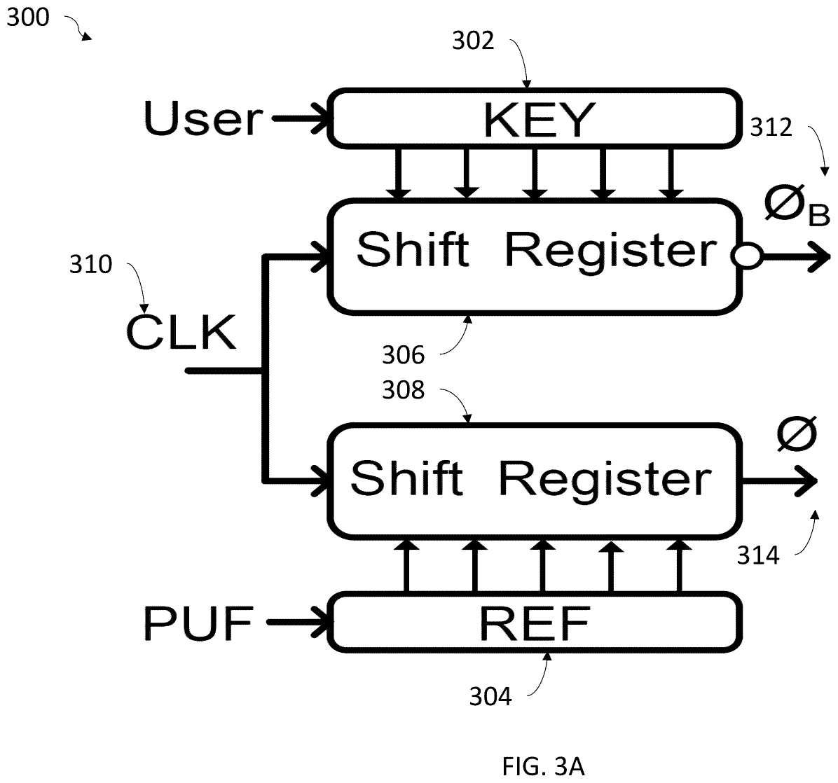

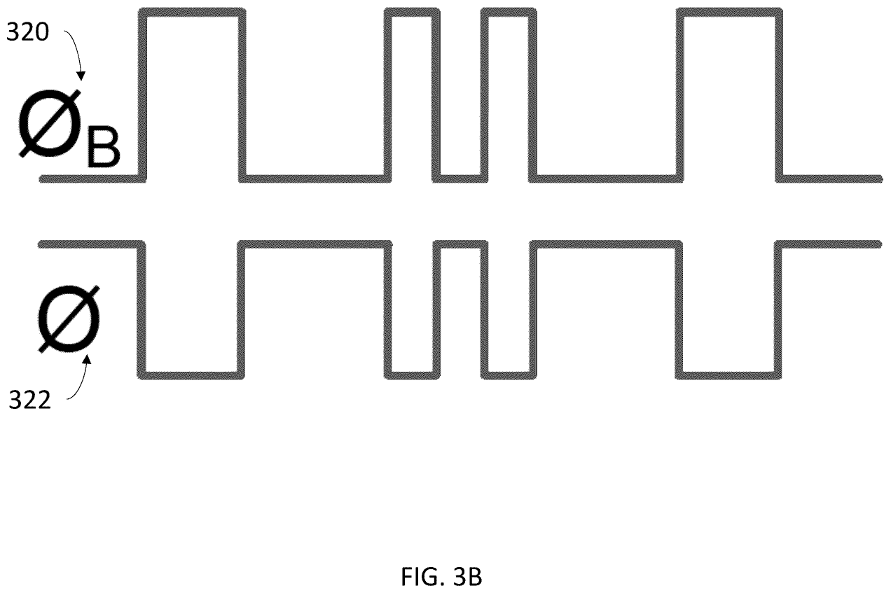

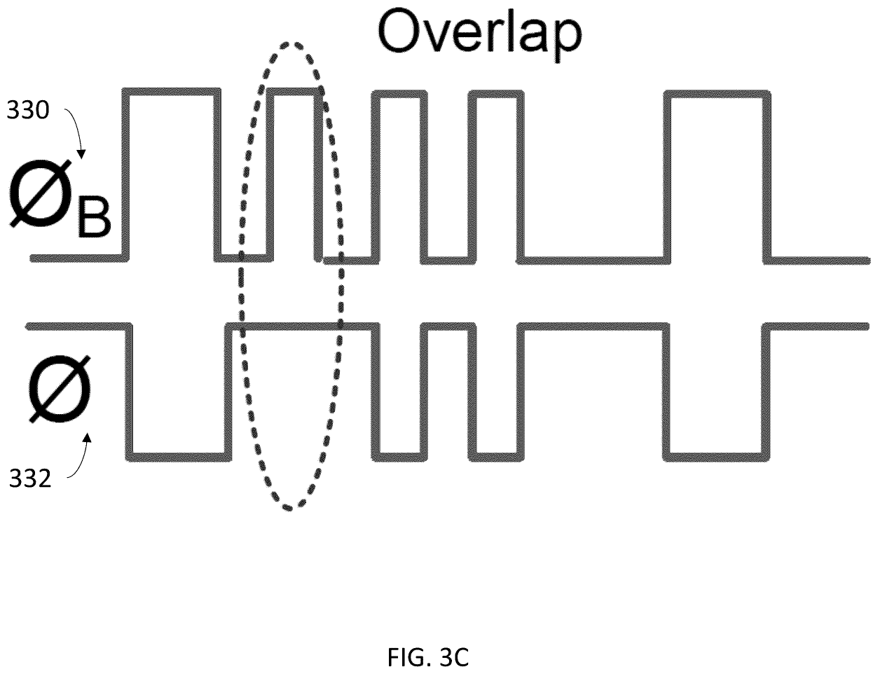

FIG. 3 depicts the techniques and systems using Switch Mode Time Domain Locking (SMDL). FIG. 3A shows the architecture of a locking circuit 300 for use with an analog circuit and a switching phase based locking technique operating on the locking circuit according to various embodiments of the present disclosure. The analog circuit locking technique (SDML) described herein may be based on separating the phases of input signals to an analog circuit, which may be adapted to perform a predetermined function, and which may be upstream of the locking circuit 300. One phase (Φ) may be a reference phase 314, which may be a the phase of a first signal (a reference signal), generated and input to the analog circuit, while the other phase (Φ_{B}) 312 may be a user provided phase, which may be a the phase of a second signal generated and input to the analog circuit. The reference phase may be generated/configured using a clock (CLK) signal 310 and a first key 304 output by a random key generator, such as a PUF unit, to set the value of a shift register/counter 308, based on the first key 304. In particular, the CLK signal 310 and the first key 304 output by a random key generator may be input to a shift register/counter 308. The output of the shift register/counter 308 may then be a random signal generated by applying the first key 304 to the CLK signal 310 to generate the reference signal, which has the reference phase 314.

Phase Φ_{B} 312 on the other hand may be generated/configured by a user. The end user may load the value of a second key 302 into a counter 306. In particular, the CLK signal 310 and the second key 302 may be input to a shift register/counter 306. The output of the shift register/counter 306 may then be a random signal generated by applying the second key 302 to the CLK signal 310 to generate the second signal, input to the analog circuit, which has the phase Φ_{B} 312. The two sift registers/counters 306 and 308 may be used to load the reference key 304 and key value 302, respectively.

FIG. 3B shows two signals 320 and 322 that are determined to include a correct key in a high-precision power sensing based adversarial attack detection technique according to various embodiments of the present disclosure. In case the correct key value are used phases Φ 322 and Φ_{B} 320 will be correctly aligned, as shown in FIG. 3B, and the downstream analog circuit will perform well and meet the specification.

FIG. 3C shows two signals 330 and 332 that are determined to include an incorrect key in a high-precision power sensing based adversarial attack detection technique according to various embodiments of the present disclosure. If the incorrect key is applied then phases Φ 332 and Φ_{B} 230 will start overlapping with each other, as shown by the circled portions of the two signals with the different phases in FIG. 3C. This will produce a short-circuit or an open-circuit inside the downstream analog circuit, leading to the breakdown of its functionality. This breakdown in functionality can be easily detected using a sensor/sensor circuitry and sensing techniques, such as clock overlap measurement techniques [26], which can then be used to indicate the adversarial attack, such as when it is carried out continuously.

### Design Considerations

There may be design overheads that are considered and accounted for during the development of the techniques and systems described herein, such as those implementing SMDL. First, the system design may require additional digital circuit and logic for its implementation. However, these circuits may be small and do not incur significant area overhead based on the key-size. Another overhead may be from using a randomized data pattern instead of a fixed clock. A random data pattern can include varying frequency pattern which can interfere with the signal being processed by the analog circuit. Analysis indicates that the implication of this design may remain minimal, for example, when the clock runs at a sufficiently high or higher frequency to keep the random data pattern transitions fast to maintain the analog circuit performance. Additional digital circuits may be used to remove long trails of 1's or 0's in the reference key. Each of the random reference keys used in the design, presented herein, for locking may show a good Hamming distance, and each random key may not have the issue of long trails of 1's or 0's in the reference key [27]. Further, the proposed system design, presented herein, can be used for authentication and the shift registers/counters can be configured for normal functionality, rather than for authentication. Compared to prior works, where a small 24-bit key can cause significant design overhead and reduce analog circuit performance, the approach proposed herein may not impact the circuit performance in the same way and may also provide flexibility to have large key values. In some examples, the locking scheme may be used for a folded cascode amplifier (FCA) and a bandgap reference circuit.

### Circuit Design

Folded Cascode Amplifier with Analog Locking

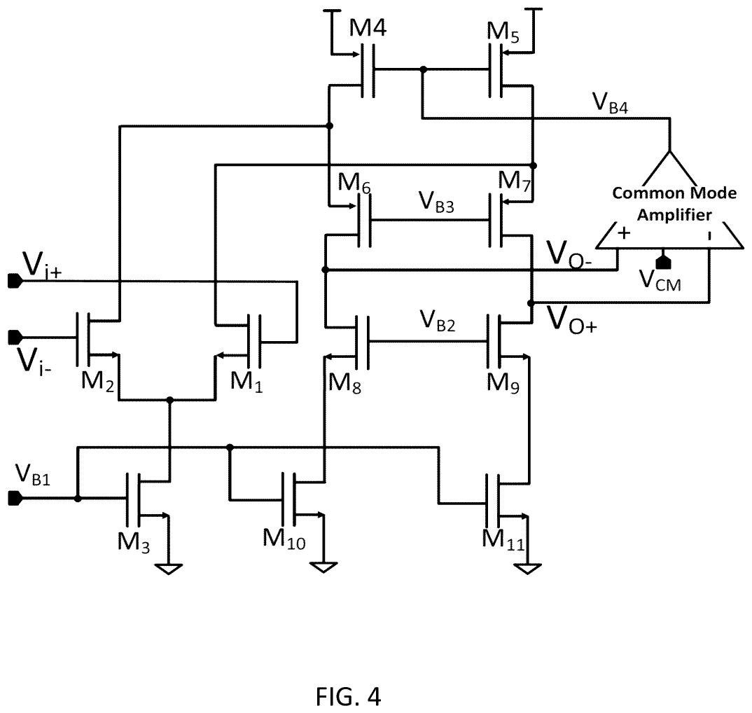

FIG. 4 shows the base topology of a FCA with a CMFB circuit. FCA may achieve high gain, wide bandwidth, and superior linearity, necessary for various analog applications. The “folded” topology of this amplifier may significantly enhance its output resistance and gain without sacrificing bandwidth. This may make this amplifier highly effective in amplifying small signals with great fidelity and in mitigating the effects of parasitic capacitance in high-frequency operations. Setting the common-mode voltage (V_{CM}) can optimize the amplifier's output signal swing, allowing for efficient utilization of the available signal range. The fully differential FCA, as shown in FIG. 4, was designed with a standard specification. This circuit is a popular choice to implement several large analog blocks due to its large gain and simplified design. In addition, this circuit was designed in 65-nm CMOS technology. It achieved a low frequency open-loop gain of 59 dB, with a bandwidth of 10 kHz and a unity gain bandwidth of 1 MHz.

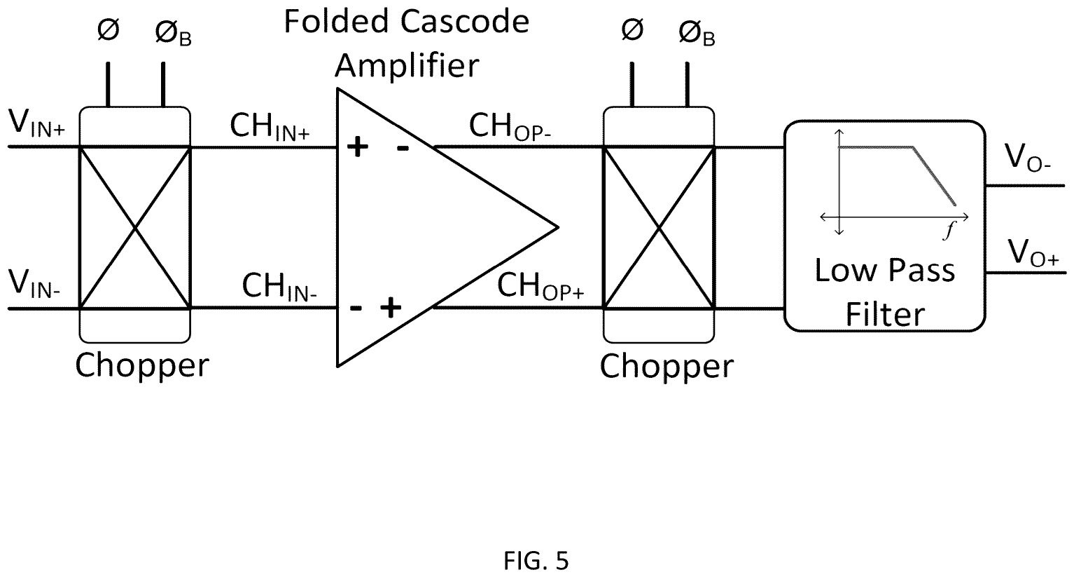

Chopping may be implemented into the FCA to achieve improved noise performance because it removes low-frequency flicker noise. The use of two complimentary phase digital signals, as is used in chopping, can then be leveraged for locking. FIG. 5 shows a circuit which includes the chopping and locking into the FCA. The input and output of the FCA in FIG. 5 is configured for modulation and demodulation using chopping circuits. The chopper circuits in FIG. 5 modulates the input signal and demodulate the amplified output. The demodulated output of the FCA, shown in FIG. 5, is fed through a low-pass filter which eliminates the high-frequency noise, the majority of which is centered around the chopping frequency. The input phases to the chopping circuits may be fed through the locking system circuitry, as shown and described with reference to FIG. 3, through the introduction of phases P and Φ_{B}.

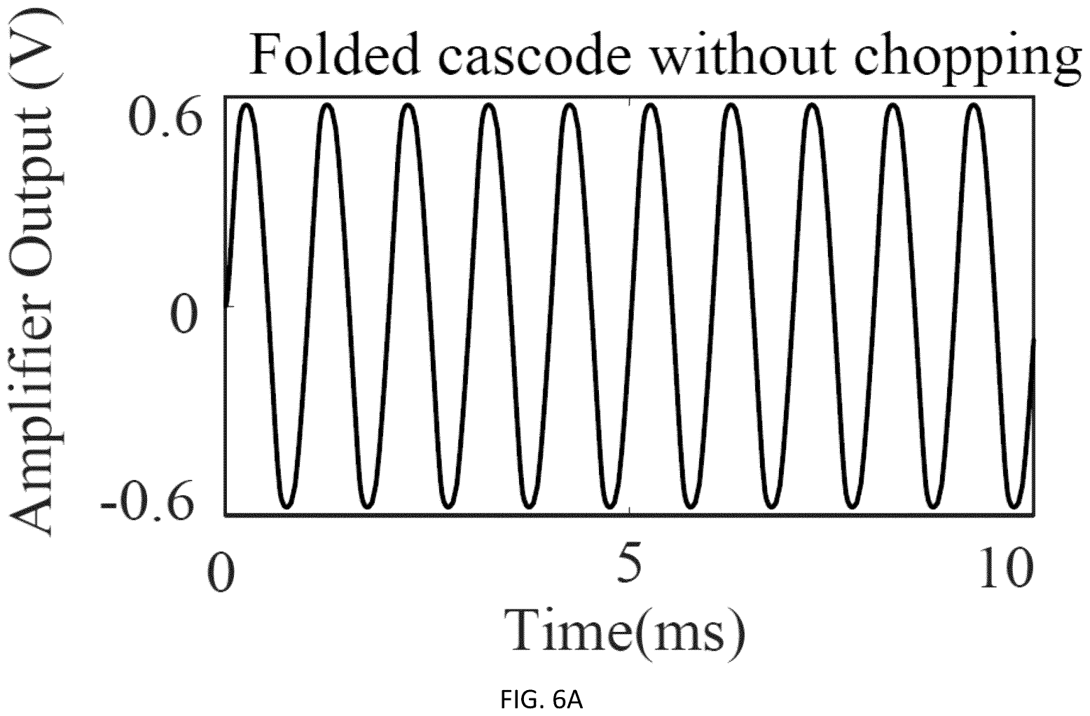

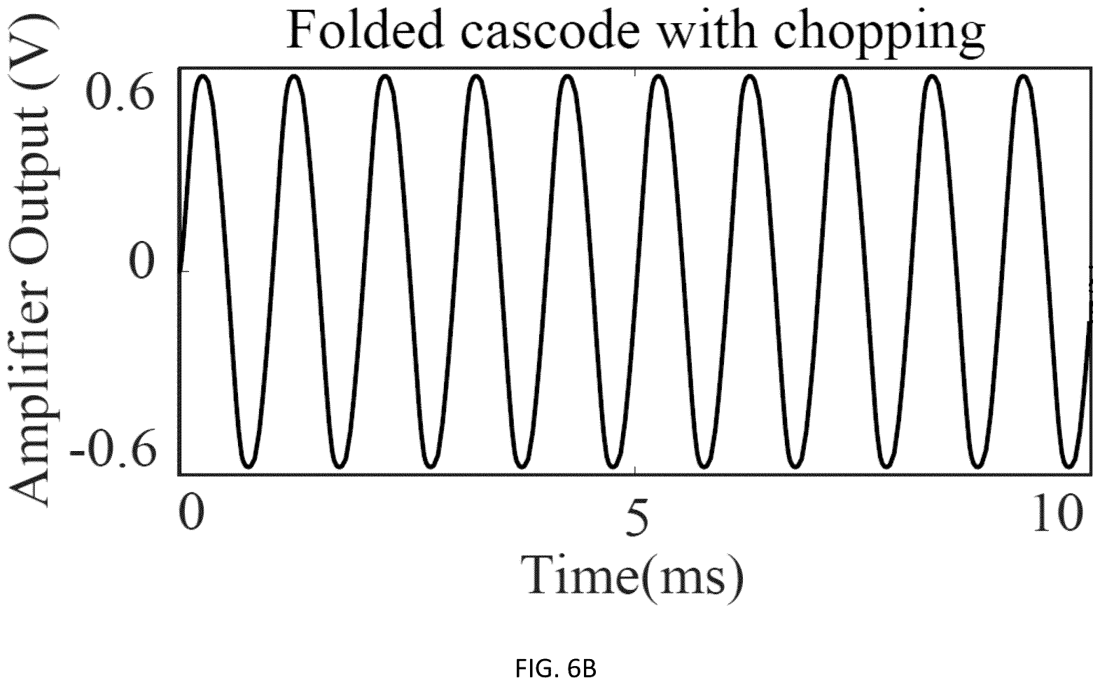

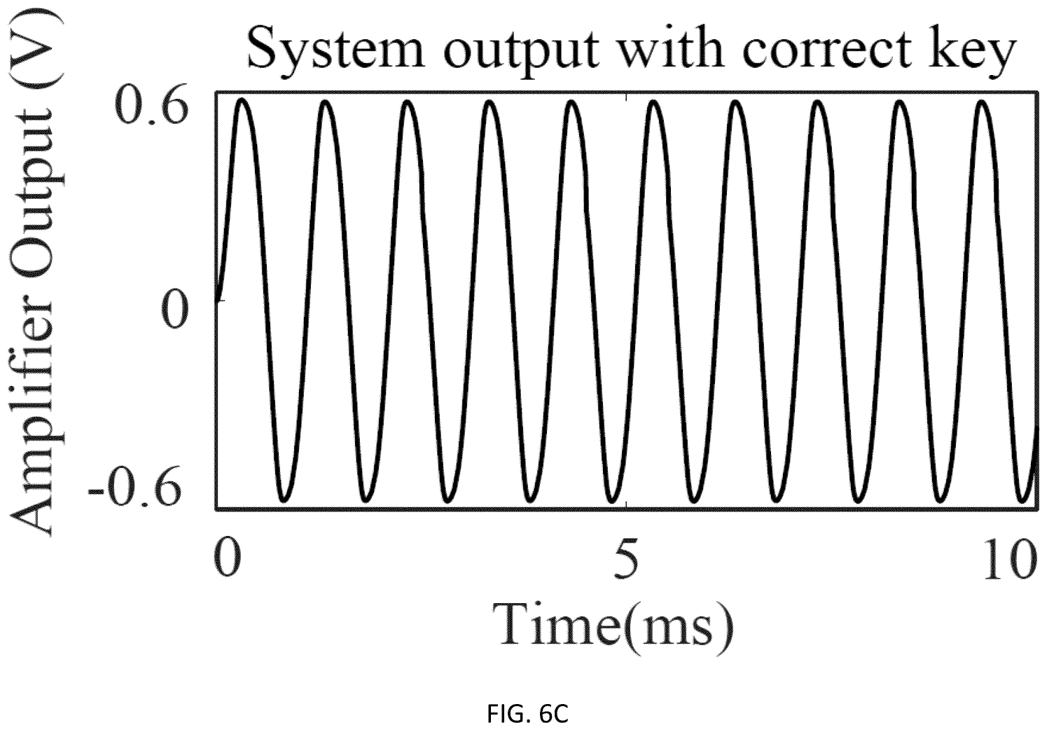

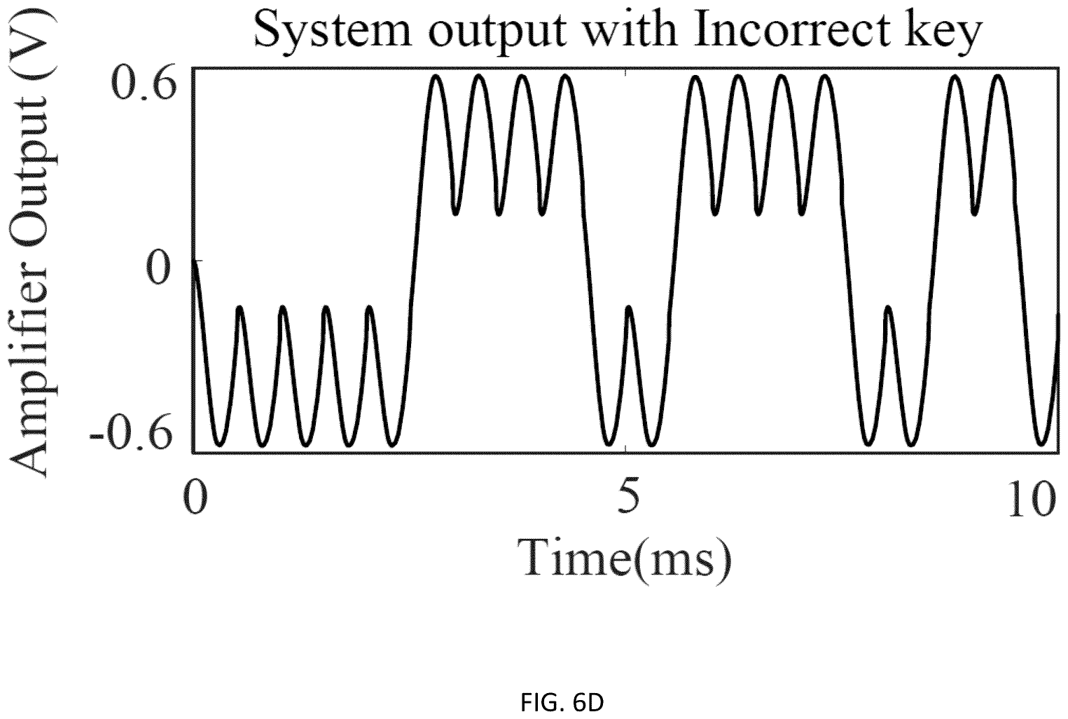

FIG. 6 shows the transient simulation result for four different application cases of the FCA using the locking technique. In this simulation, the output of the FCA was obtained using an input signal of 1 mV at 1 KHz. FIG. 6A shows the output of the FCA without chopping. It achieved a peak-to-peak output swing of 1 V. Chopping was then incorporated into the amplifier using chopper and a low pass filter as shown in FIG. 5. In this case (and (s were non-overlapping clock input like in a conventional version of the circuit. FIG. 6B shows that the output achieved a swing of 1 V. In the third case, the chopper input was changed to a key-based random digital input. Here, the correct key input was applied. FIG. 6C shows the simulation result with this correct key input applied. It still achieved 1 V swing like in previous cases. Finally, (and (s were implemented with an incorrect key, the simulation result of which is shown in FIG. 6D. In this case the output of the amplifier got corrupted due to wrong phases of the lock.

### Locking Switched Capacitor Bandgap Reference

A reference voltage may be an essential component for most integrated circuits, because they may be used for critical functions such as voltage regulators, analog to digital conversion (ADC), digital to analog conversion (DAC), and precision measurements among other applications. The bandgap reference (BGR) generation circuit may be a popular choice for generating voltage references. Such a circuit can use a pair of bipolar transistors (BJTs) to generate a proportional to absolute temperature (PTAT) voltage and a complementary to absolute temperature (CTAT) voltage. Using amplifiers, current mirrors, and resistors the CTAT and PTAT voltages may be added with the right scaling factors to generate a voltage independent of temperature, process and supply voltage (PTV) variations. However, conventional BGR design method may require the supply voltage to be higher than 0.9 V to realize proper biasing. Additionally, resistor values in 100's of MΩ, costing large device area, may be need to realize ultra-low power BGR.

Recently, switched capacitor based BGR generation has gained popularity as these can realize large resistors using small switching capacitors thus lowering area. Additionally, the switched capacitor scheme also lends well to realize BGRs from lower voltages overcoming the high power supply requirements. For example, Shrivastava reported this first in [25] which was followed by several recent works [28]-[31].

A locking scheme may be used for switched capacitor BGR circuits. Because BGR realizes a critical function for several analog circuits, locking the BGR will lock the functionality of the analog circuits as well. A new subtractor-based BGR circuit low voltage reference is presented which can be used to demonstrate locking method. However, the locking scheme, described herein, is general and may apply to any type of switched capacitor BGR.

1) Subtractor BGR Concept: The subtractor-based BGR may use a different set of equation for V_{REF} generation which are given by,

$${V}_{REF} = {V}_{EB 1} - {KV}_{EB 2} , \qquad ( 1 )$$

which equates to

$${V}_{REF} = Δ {V}_{EB} + ( 1 - K ) {V}_{EB 1} . \qquad ( 2 )$$

Equation 2 shows the CTAT and PTAT parts in a similar format as in conventional BGR. This results in K≈0.9 because the temperature coefficient of ΔV_{EB} may be around 0.2 mV/° C. and that of V_{EB2} may be around −2 mV/° C. The subtractor topology can implement equation (1), as shown below. The other circuits (2 ×charge-pump, clock generation) can remain similar to the work reported in [25]. In the subtractor BGR, described herein, a 1.2 V minimum supply was used to focus the work primarily on the locking scheme. As discussed below, a V_{REF} of 109 mV was achieved owing to the smaller scaling factors on V_{EB2} and ΔV_{EB}.

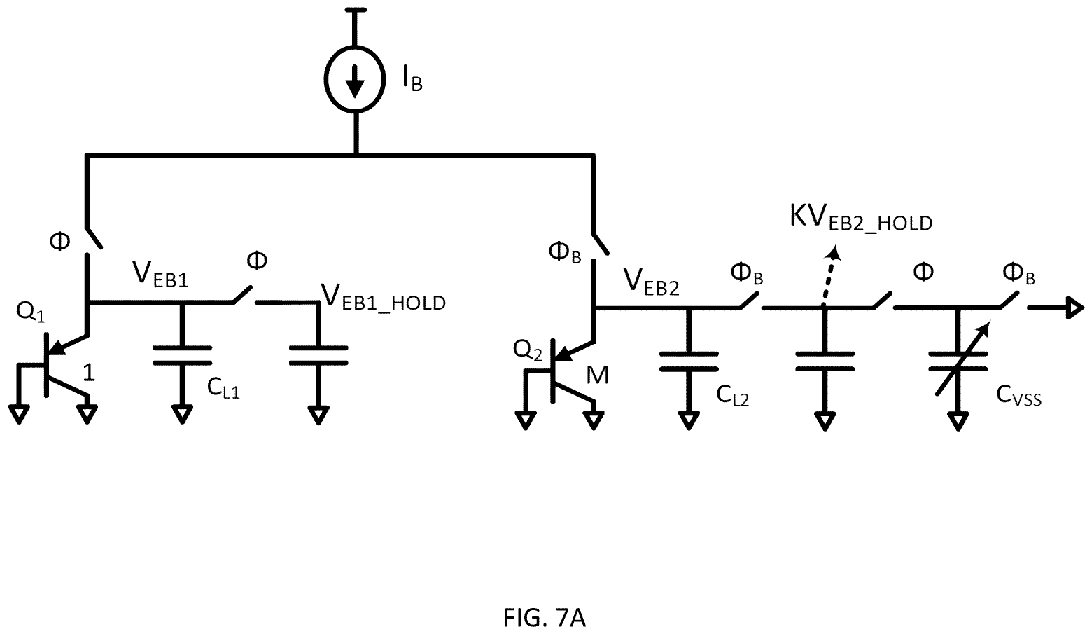

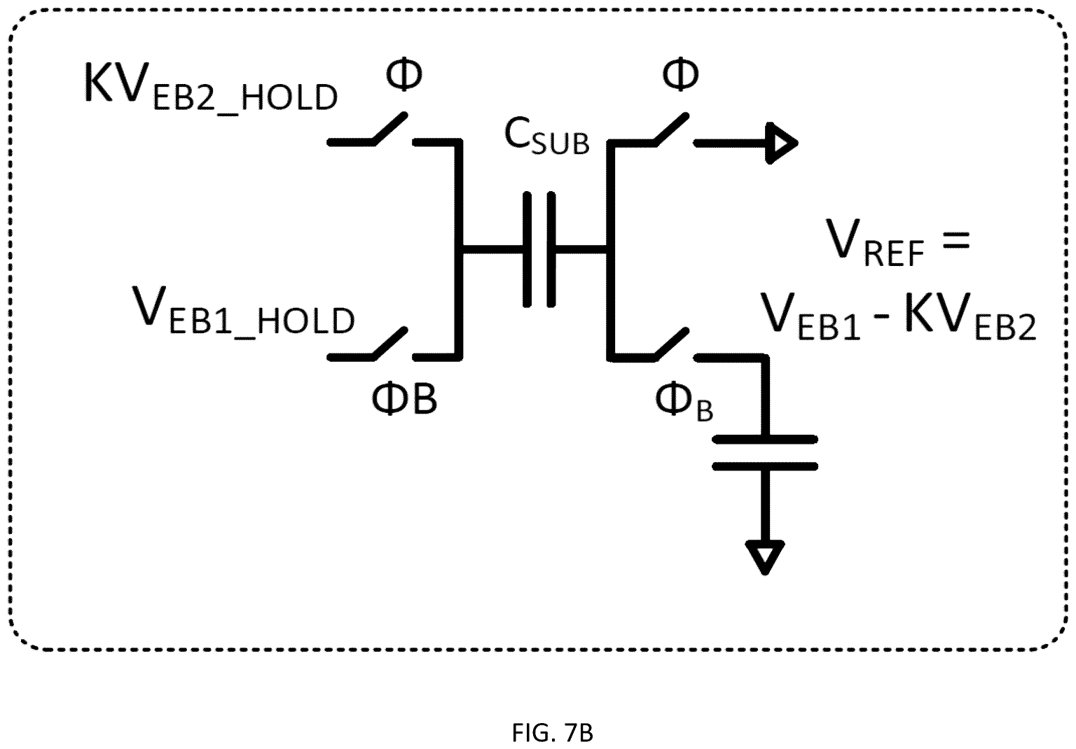

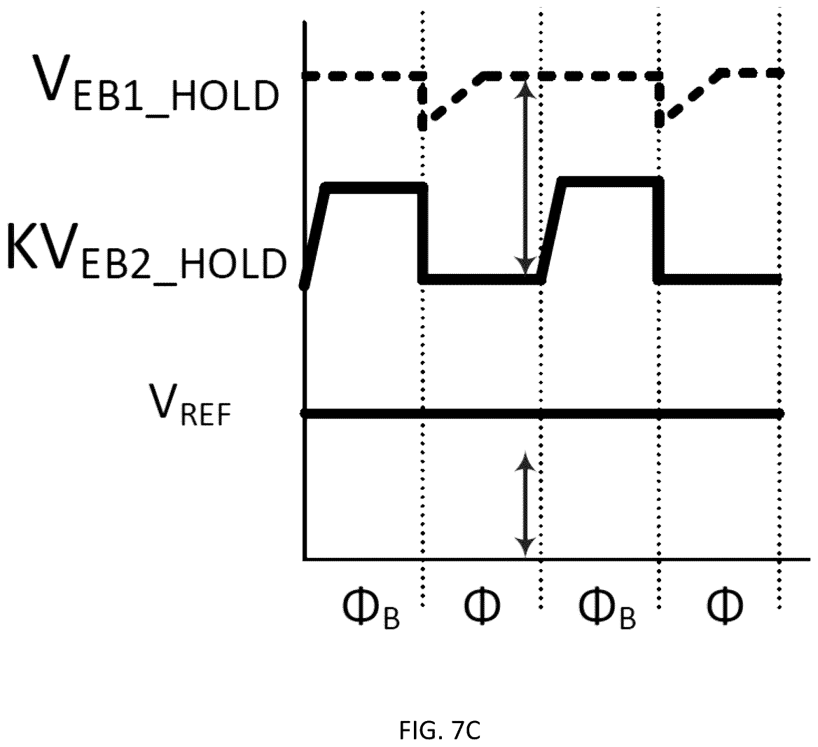

2) BGR Circuit Design: FIG. 7 shows the topology of the switch capacitor subtractor-based BGR. FIG. 7A shows a BJT Biasing and V_{EB} generation circuit. BJTs may be biased using current mirrors instead of a 2×CP (which can also be used for lower supply voltage implementations). Load capacitors (C_{L1} and C_{L2}) on the BJTs may reduce the switching ripple and maintain V_{EB1} and V_{EB2} at close to DC level. This may be critical because it avoids having a large voltage drop across the next switch and thus lower leakage on the V_{EB1_HOLD} and KV_{EB2_HOLD} nets. FIG. 7B shows a subtractor circuit. V_{EB1} may be sampled and held on V_{EB1_HOLD}. V_{EB2} may be sampled and held and thereafter scaled by a factor of K on KV_{EB2_HOLD} by charge sharing a grounded capacitor C_{VSS}. Finally, V_{EB1_HOLD} and KV_{EB2_HOLD} may be subtracted to create V_{REF} using a switch capacitor subtractor circuit. FIG. 7C shows a resulting timing diagram of V_{EB1_HOLD}, V_{EB2_HOLD}, and V_{REF} and different phases.

The subtractor based topology, as show in FIG. 7B, may sample both V_{EB1} and V_{EB2}, and then subtract them. Further, the subtractor may be a near-differential structure. Thus, to the first order, errors caused by charge injection (CI) and clock feedthrough (CF) may get cancelled out. The disadvantage of the subtractor topology may be the lower value of V_{REF}. However, with device scaling and lower voltage systems becoming popular, the subtractor topology can be a useful option.

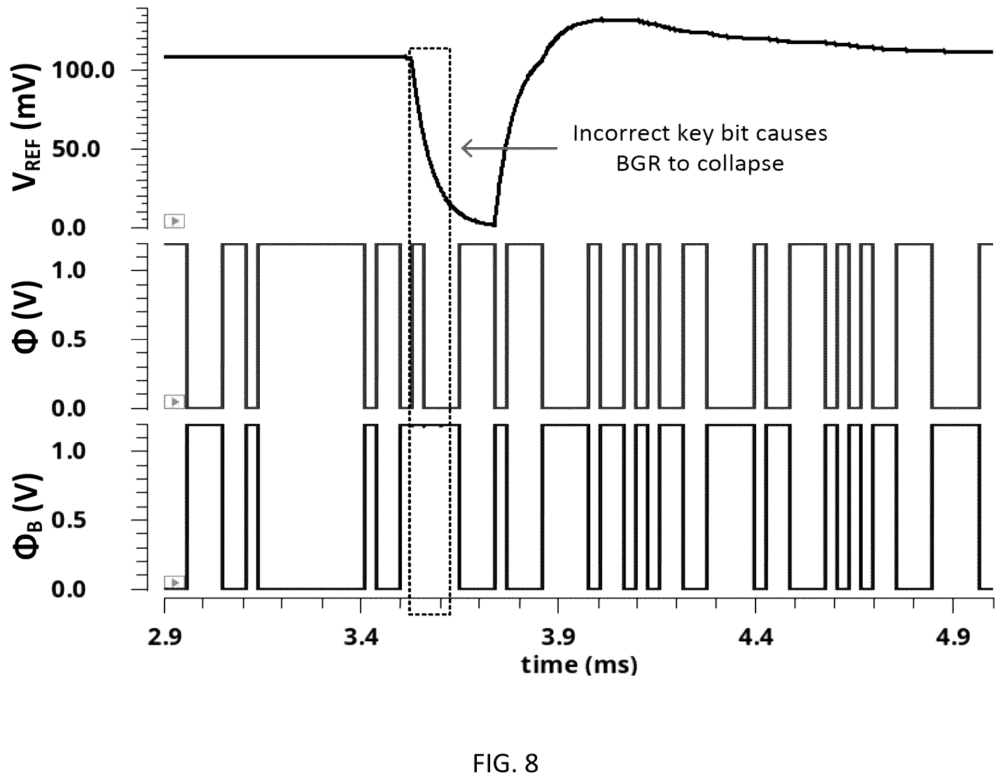

3) Simulation Results: FIG. 8 shows the transient simulation result of the switched-cap BGR circuit with an incorrect key. As shown, initially the switched-cap BGR circuit reached the correct voltage value of 109 mV in the presence of correct key bits. However, its output voltage collapsed when an incorrect key-bit was introduced. The output again reached the correct value after several correct bits were introduced. In this simulation, the response of the switched-cap BGR circuit with only one incorrect key bit was shown. Because BGR is a critical analog circuit that often provides reference voltages/currents for other analog circuits, locking it can effectively lock other analog blocks. This may play a critical role in the security of analog circuits such as voltage regulators and ADCs [4].

### Analog Locking Analysis and Results

The proposed analog locking scheme, described herein, combines hardware security principles into analog circuit design. Such a scheme meets both analog circuit as well as hardware security design goals. This may be essential as either a compromised analog circuit goal or a limited security feature may render the design a less appealing choice. Below, different simulation results are provided to evaluate analog circuit performance and security. Circuit simulations were performed with correct and incorrect keys to demonstrate the effectiveness of the proposed locking scheme. These simulations evaluated output signal quality, variation in frequency content, correlation over time, as well as key security measures such as entropy, auto-correlation function, and hamming distance.

### Evaluation of Key

The size and randomness of the key may play an essential role in hardening circuit locking. As analog circuit functionality is locked in time, the key size can be arbitrarily long, similar to conventional encryption schemes. Larger keys may offer more security but may also result in slower encryption and decryption process. RSA keys may typically range from 1024 to 4096 bits. Similarly, the key sizes of elliptic-curve cryptography (ECC) may range from 160 to 521 bits. Advanced Encryption Standard (AES) may use key sizes of 128, 192, or 256 bits. In the simulations described below, 128-bit keys were used. These keys can be generated using analog PUF circuits/units [32].

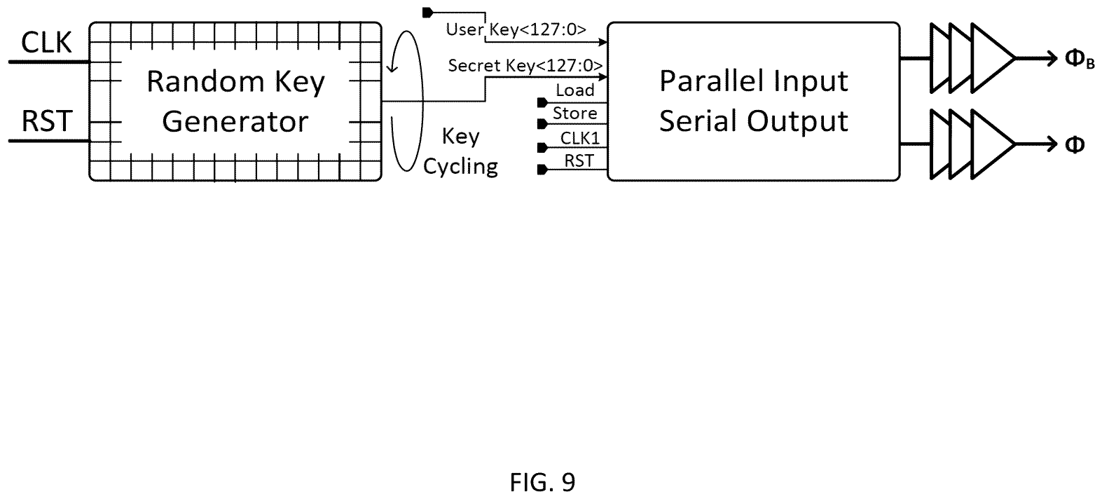

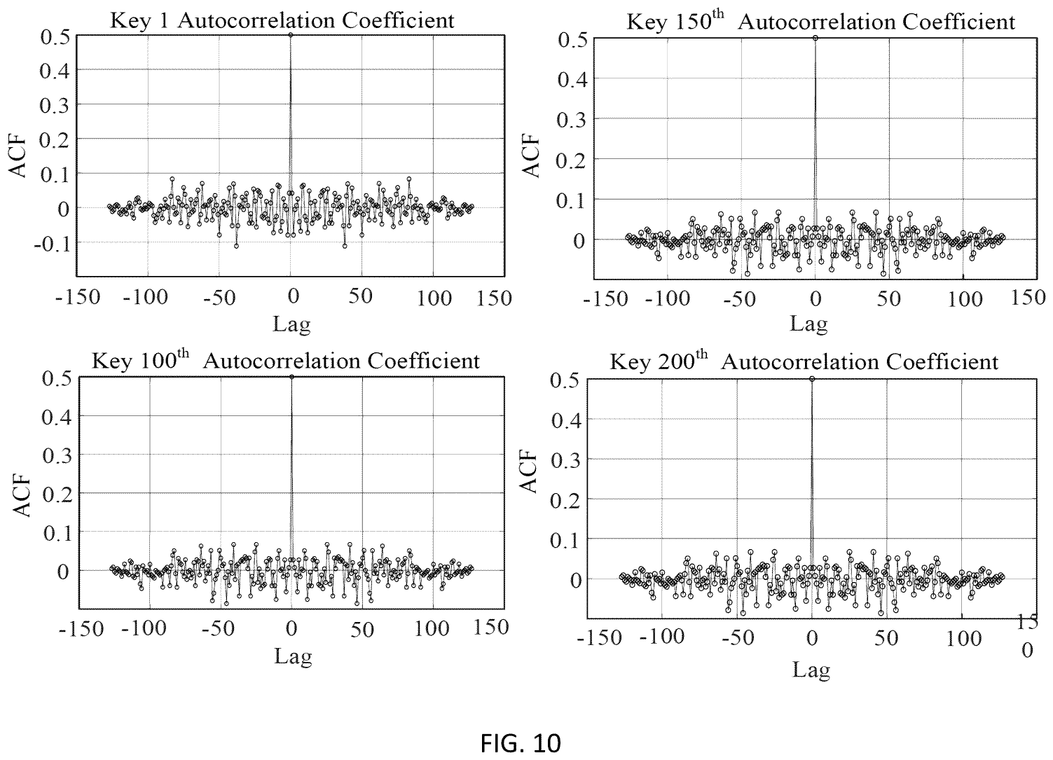

FIG. 9 shows a block diagram for a random key generator that was used for evaluating the SMDL technique. Random key generators may be commonly used in cryptography applications to generate long keys such as PUFs. PUF circuits/units may be unclonable due to random components that they contain from manufacturing variations. These keys may be used to add a substantial amount of unpredictability, strengthening the locking of analog integrated circuits against attempts at manipulation and reverse engineering. 200 random keys were generated, for the simulations described with reference to FIG. 10, where each key had a length of 128 bits. The keys were fed to the parallel-input serial-output (PISO) interface. Such a PISO block can be advantageous because the system may require interface transmission of the key or serial processing in subsequent steps. The PISO block can serialize the 200 key sequences of 128 bits each, creating a streamlined output that is subsequently employed as clock signals for the switching circuits. The sequential transmission of serialized keys to the switching clock inputs can ensure their timing and synchronization. The load and store commands in the key generator can facilitate the dynamic updating and retention of the cryptographic keys, ensuring the serialized random switching input to any downstream analog circuit.

Tests were performed to verify the randomness of input keys. This may be essential to prevent against a brute-force attack. An auto-correlation function may serve as a statistical tool to validate this randomness. For a key to be considered random, its auto-correlation should be significant only at a zero lag, where a sequence perfectly aligns with itself, indicating that each part of the key is statistically independent from other parts. At any non-zero lag, the auto-correlation should approach zero, reflecting the absence of patterns and ensuring high entropy. FIG. 10 shows the auto-correlation plot of four randomly selected key sequences (keys 1, 100, 150, and 200 of the 200 randomly generated keys). It shows an auto-correlation coefficient value between −0.1 to 0.1. A sharp peak at zero lag and near-zero values at subsequent lags may indicate a sufficiently high randomness needed for cryptographic keys.

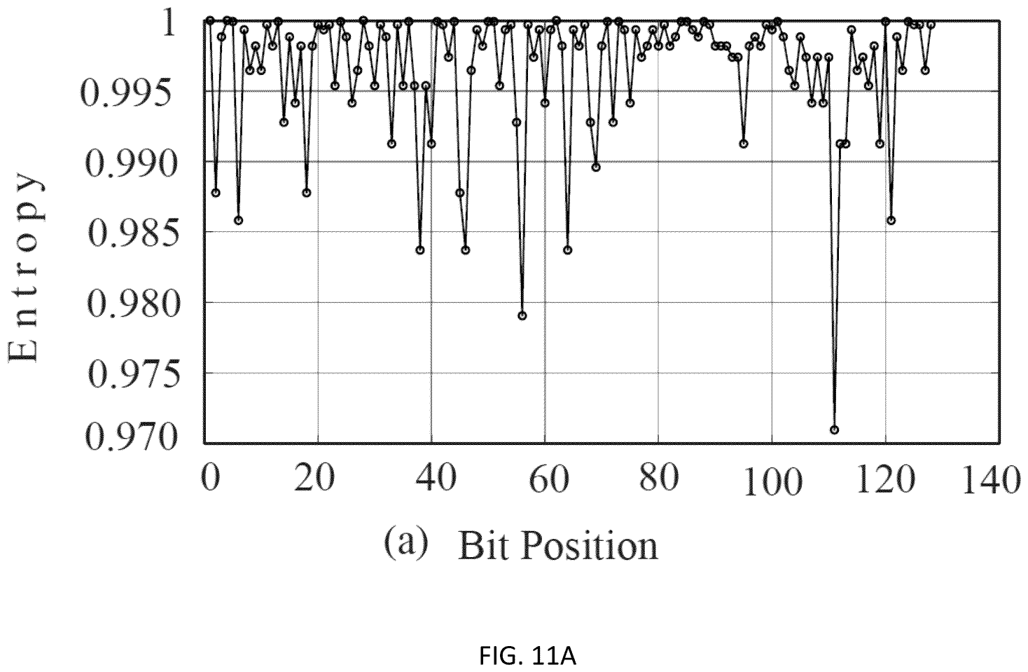

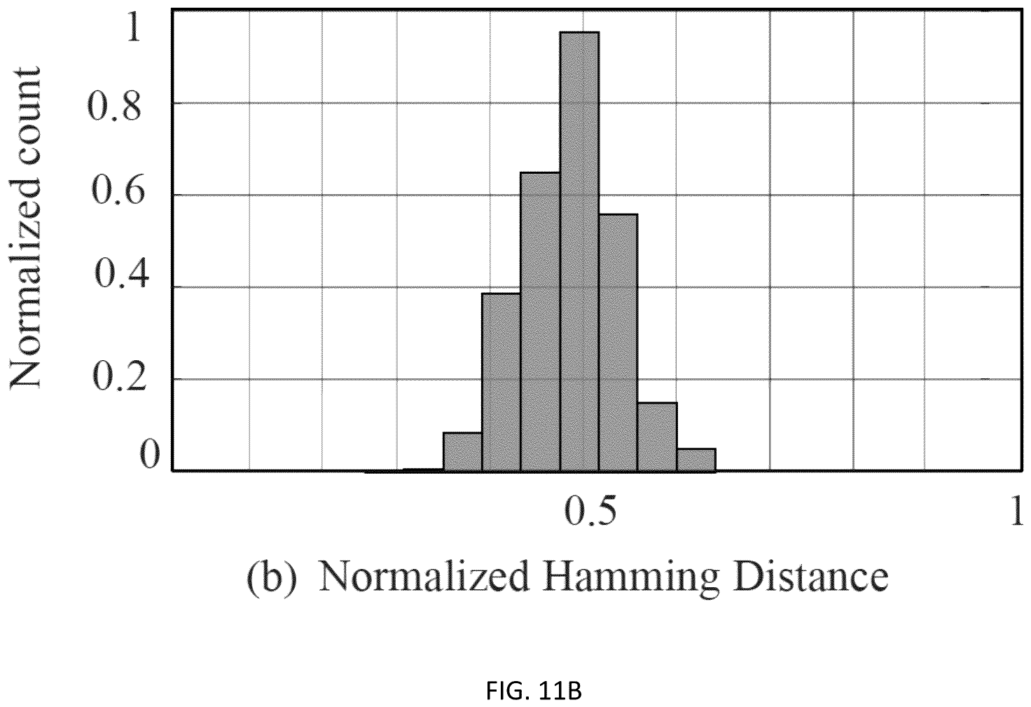

The Hamming distance of the randomly generated keys was also examined. The Hamming distance is a measure that indicates how different two cryptographic keys are by counting the number of positions where they differ. A larger Hamming distance can mean that the keys are more distinct, which may be crucial for security, because it may minimize the risk of brute-force attacks. The determination of the Hamming distance can help to evaluate the effectiveness of a key generator and key selection, ensuring our security measures are robust. The simulation results in FIG. 11 showed a normalized Hamming distance of 0.5 between two 128-bit cryptographic keys, which indicated optimal dissimilarity.

### Circuit Analysis Results of Folded Cascode Amplifier

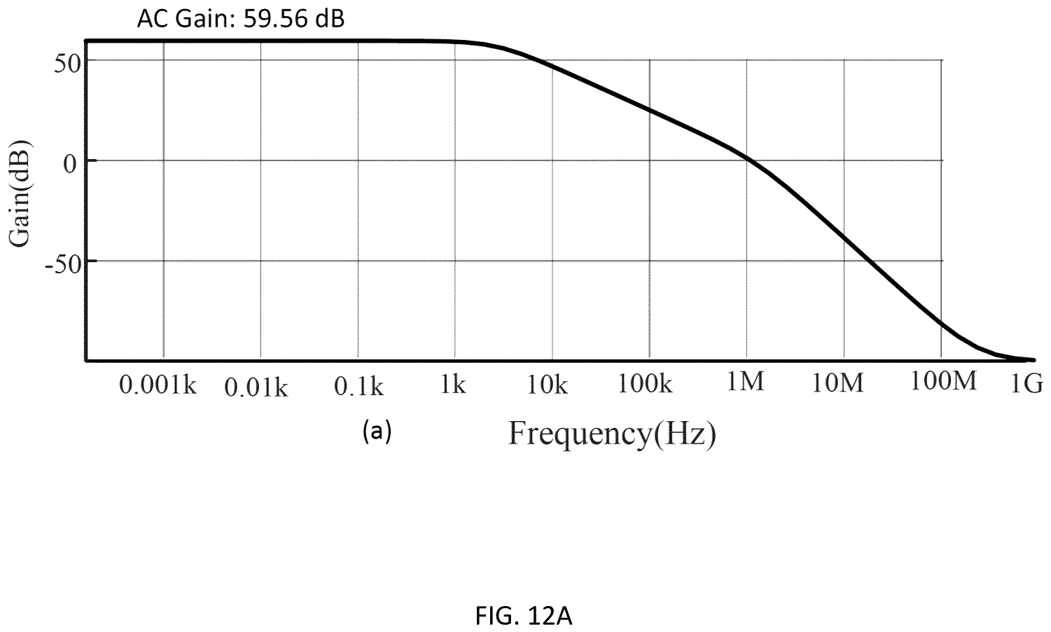

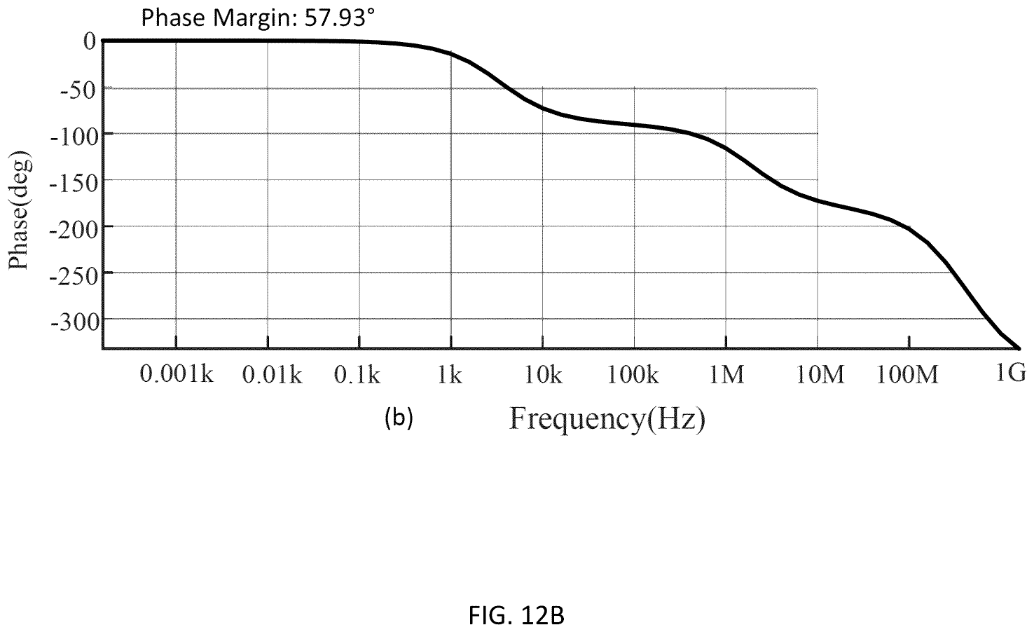

A chopper amplifier circuit was designed using a two stage FCA in 65-nm CMOS technology. FIG. 12 shows the simulation result, simulating a chopper amplifier circuit designed in 65 nm CMOS technology, showing gain (FIG. 12A) and phase response (FIG. 12B) of the amplifier. The amplifier described with relation to FIG. 12 achieved a low frequency open-loop gain of 59.50 dB, with a bandwidth of 10 kHz and a unity gain bandwidth of 1 MHz. For a negative feedback closed-loop configuration, this amplifier showed a phase margin of 58° to achieve good slew rate with high stability. The transient result of the locking was previously shown with reference to FIG. 6. The results showed how this amplifier circuit performed in different cases. The output of the amplifier remained the same in both cases, i.e., when clock is used in a more conventional architecture versus when a random key pattern was used. However, when an incorrect key was used, its output was corrupted.

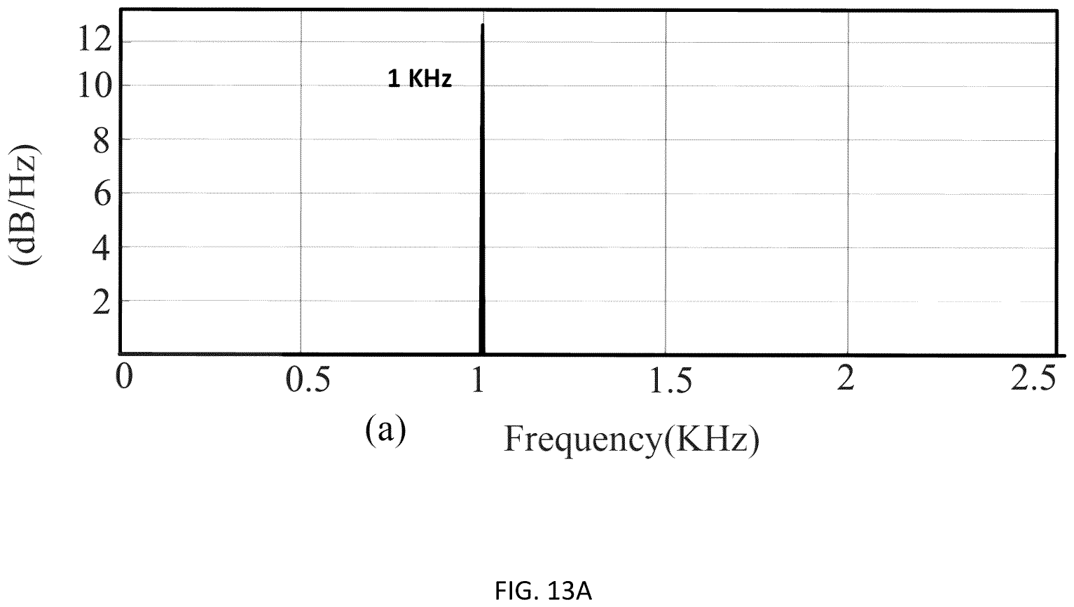

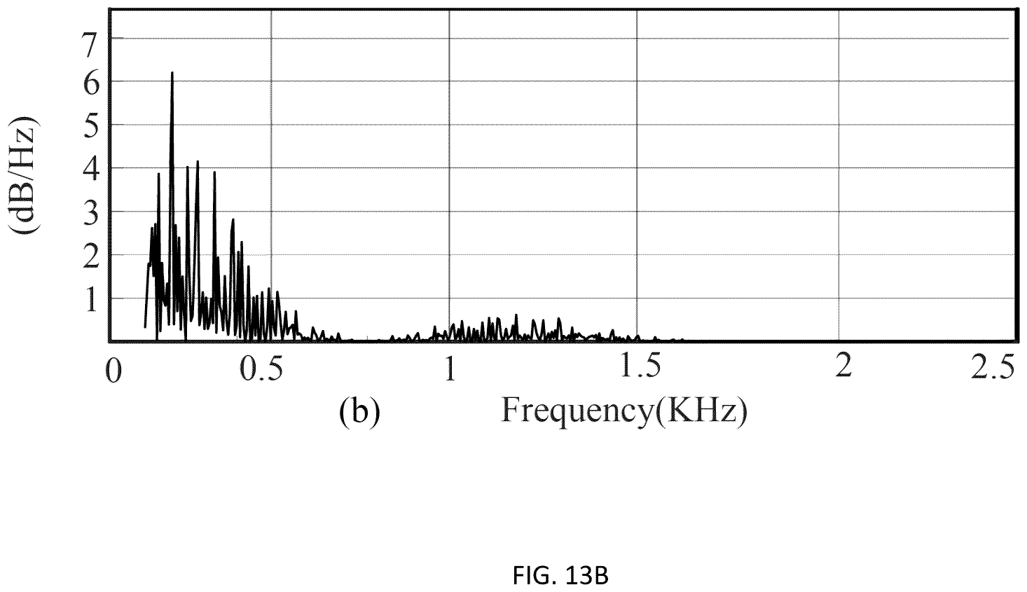

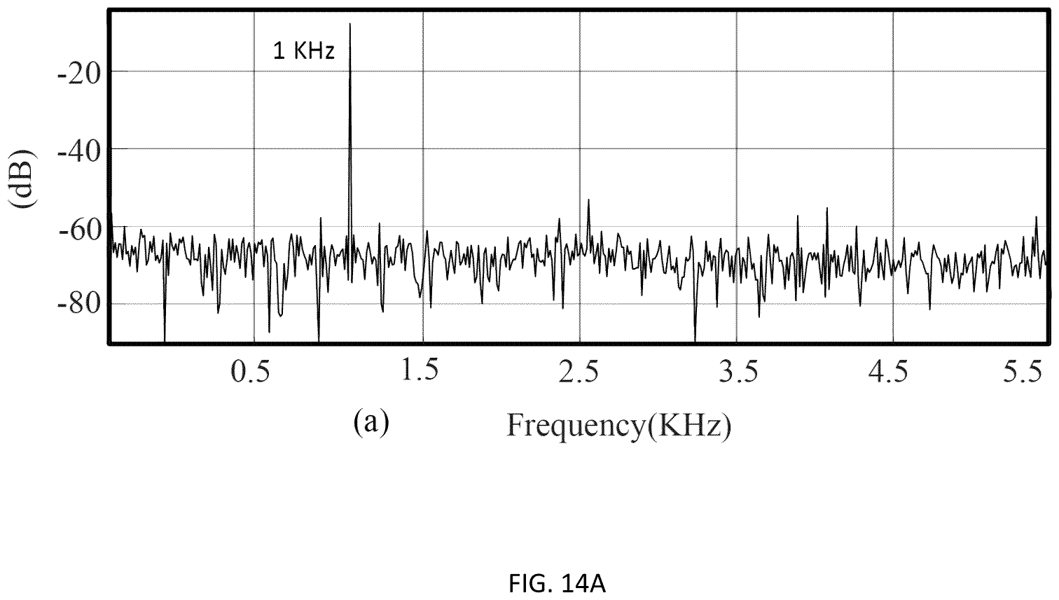

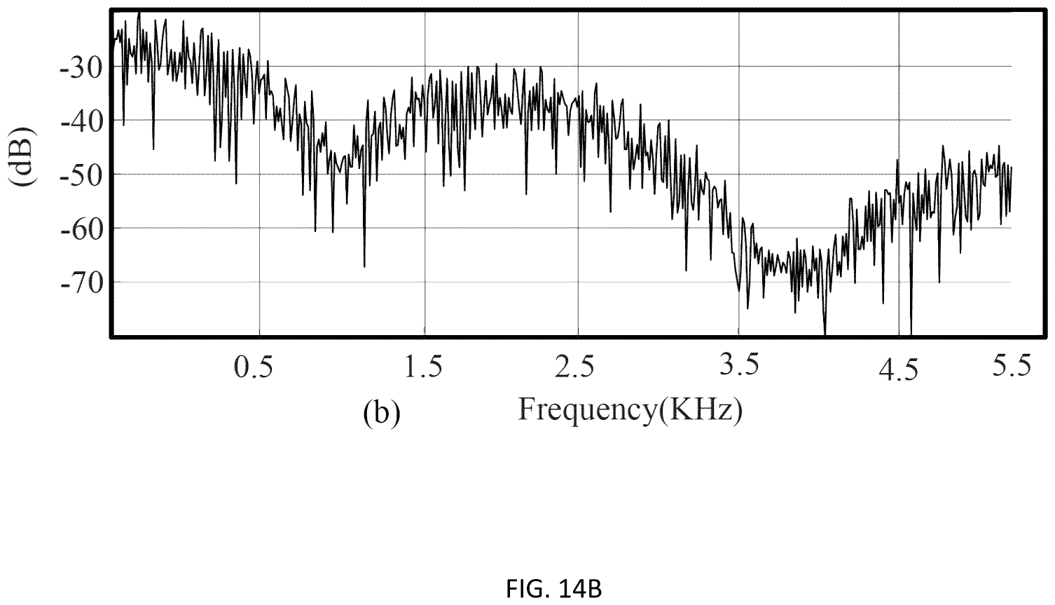

The impact of an incorrect key was evaluated on the frequency content of the output signal. FIG. 13 shows the PSD simulation result where an input signal of 1 KHz was applied to an FCA. FIG. 13A shows the PSD of the output signal when a correct key was applied. The output power sat entirely at 1 KHz, which showed the high linearity of the amplifier. FIG. 13B, on the other hand, shows the PSD when an incorrect key was applied. Owing to the modulation of the input signal with an incorrect key, the spectral content of the output signal was widely distributed. Similarly, FIG. 14 shows the discrete Fourier transform (DFT) of the output signal of a chopped FCA with a correct key (FIG. 14A) and with an incorrect key (FIG. 14B) applied. These figures show a loss of signal information with the incorrect key. The locking technique completely hid the signal's spectral information.

The typical operation of a chopped FCA with a clock source, i.e., clock-based chopping, may be well understood. Because chopping was implemented using a random key pattern instead of a clock source, the circuit performance both with a clock-based and key-based chopping was compared to quantify variation in circuit performance.

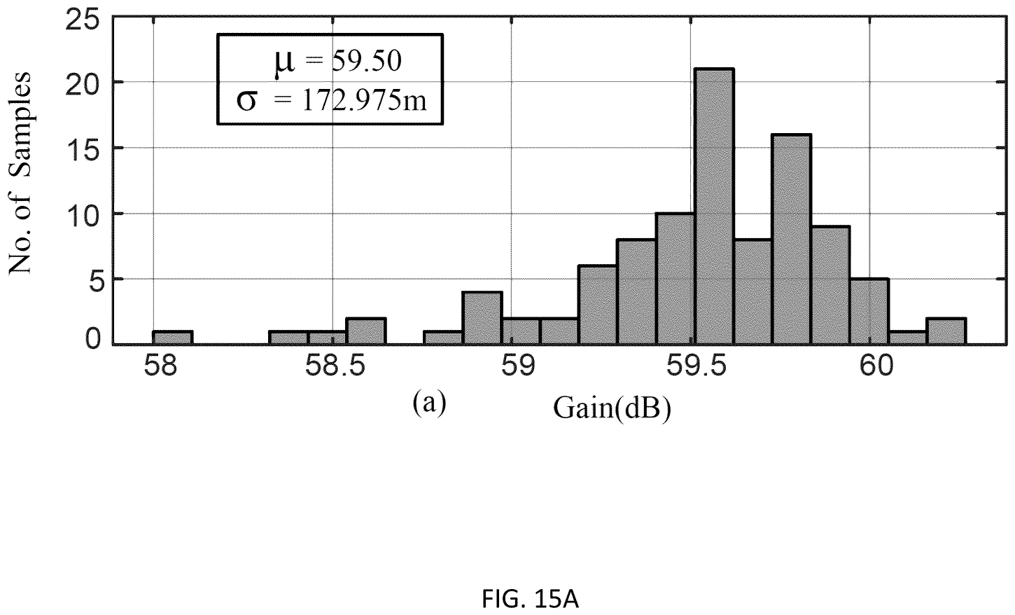

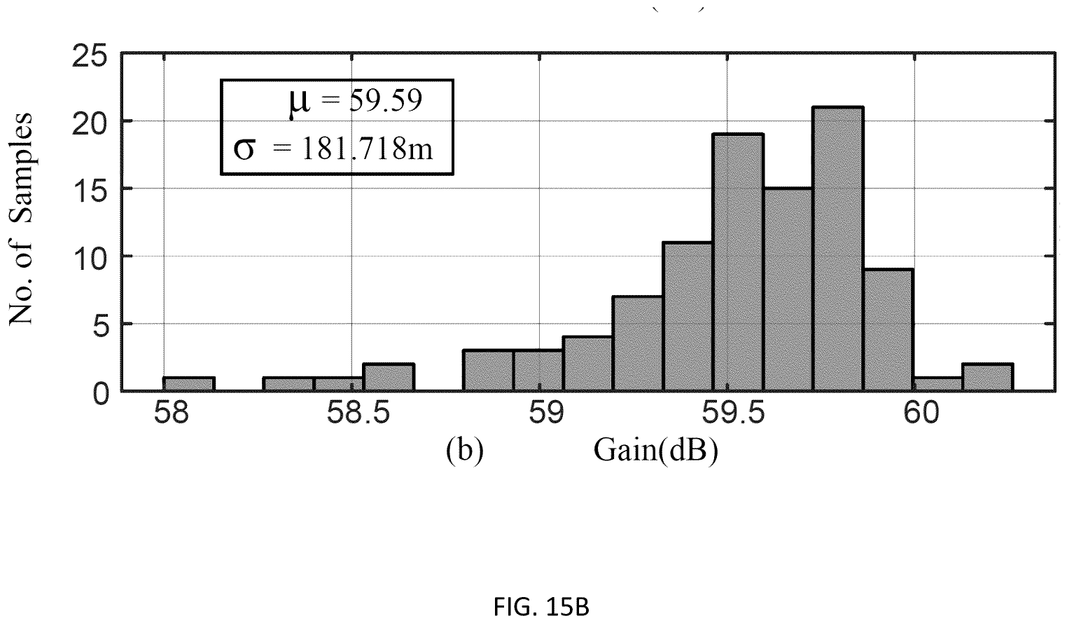

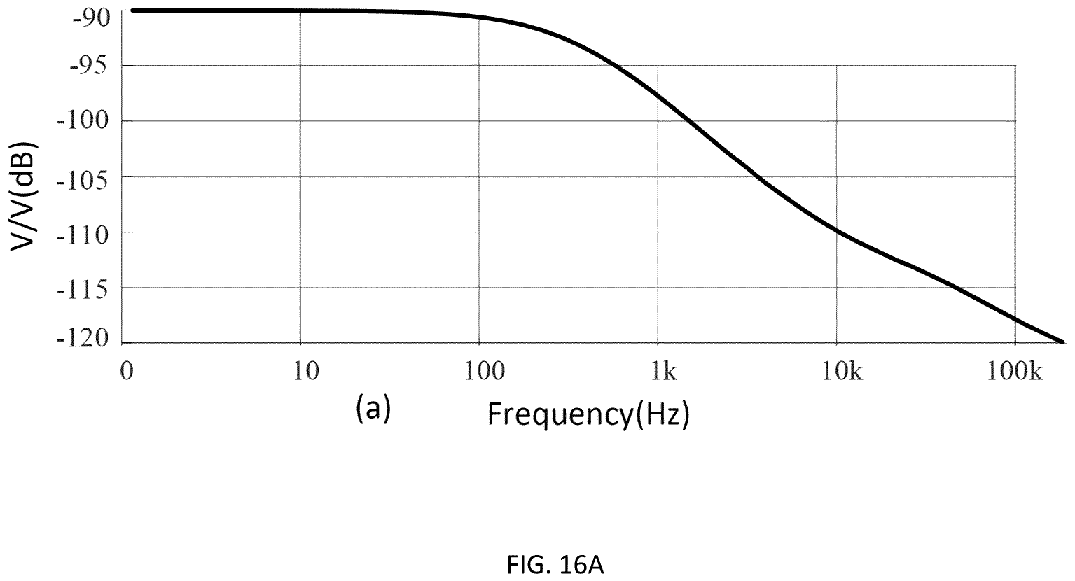

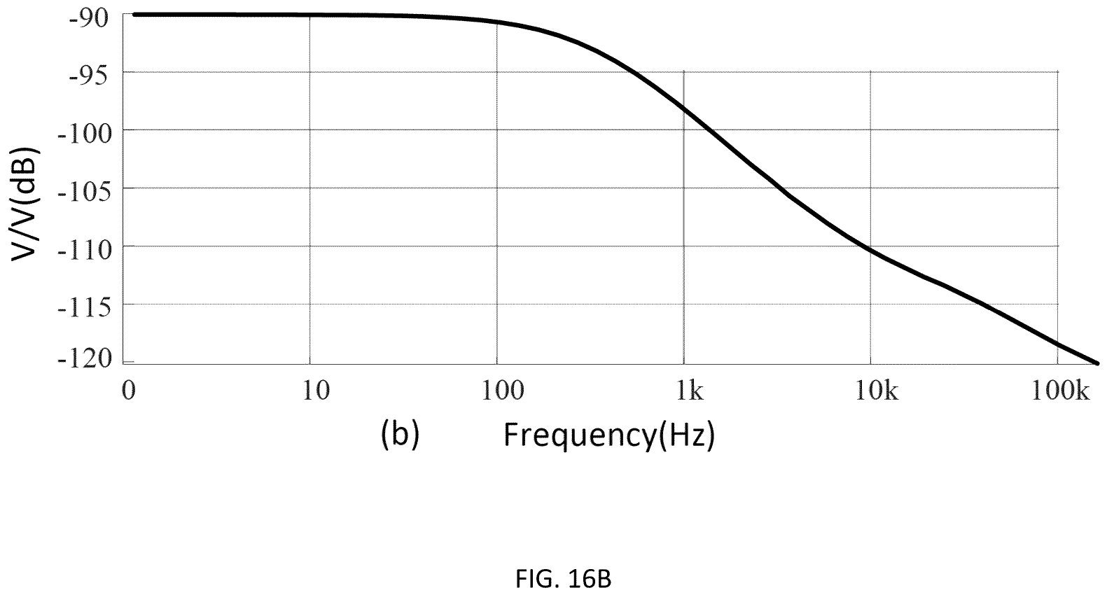

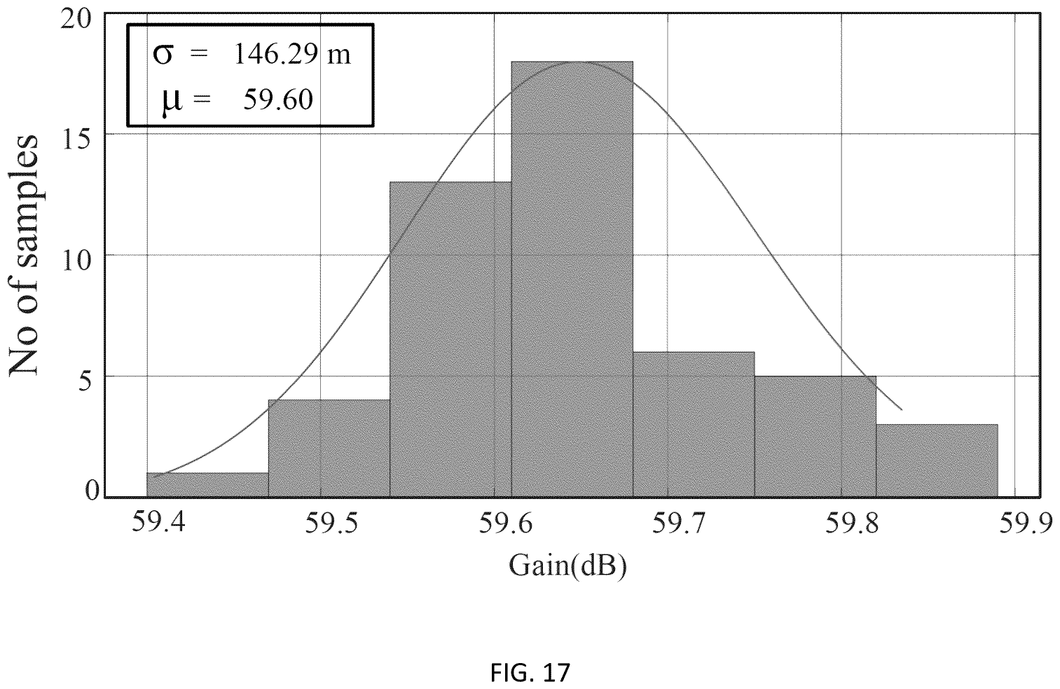

FIG. 15 shows the result of a 100-point Monte-Carlo simulation that was used to assess the impact of process variation on FCA gain using a foundry supplied device model. FIG. 15A shows the simulation result with clock-based chopping. FIG. 15A shows that the amplifier had a mean gain (μ) of 59.50 dB with standard deviation (a) of 173 mdB. Simulation of key-based chopping is shown in FIG. 15B. As shown, the amplifier had a μ of 59.59 dB and a σ of 181 mdB. The simulation results in FIG. 15B show that the gain of the FCA changed by 0.1%. Similarly, the FCA's power supply rejection ratio (PSRR) was simulated (FIG. 16) with clock-based chopping (FIG. 16A) and key-based chopping (FIG. 16B). Both simulations showed that the PSRR level of −90 dB was achieved with no meaningful difference in the output. The gain of the FCA was also simulated with different 50 different, 128-bit keys to assess the variation of amplifier gain across the keys. FIG. 17 shows the histogram and normalized distribution of the gain across 50 different keys. The observed gain exhibited a variation of (±0.41%) around a mean gain of 59.6 dB, which reflected a precise and controlled variation within this specified range.

### Circuit Analysis Results of Switched Capacitor BGR

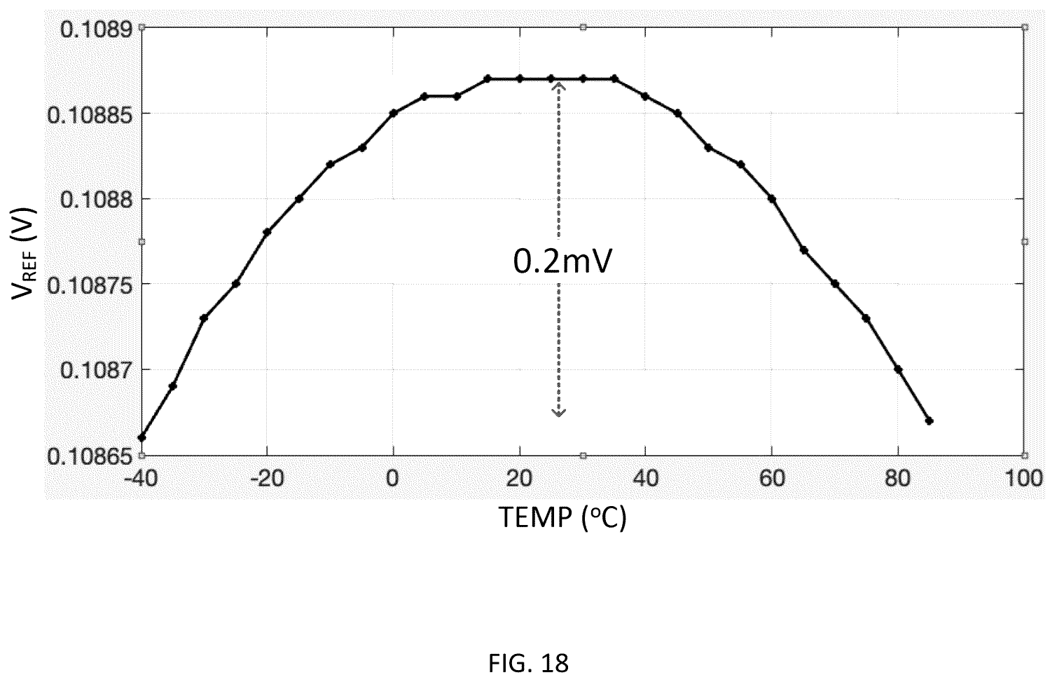

The switched-capacitor BGR circuit shown in FIG. 7 was designed in 65-nm CMOS technology. The circuit achieved a low voltage reference of 109 mV. FIG. 18 shows the simulation of the BGR circuit across a temperature variation of −40° C. to 85° C. It shows a total variation of 0.2 mV across a 125° C. temperature variation. This corresponded to a temperature stability performance of 15 ppm/° C. The temperature stability performance of the BGR circuit was comparable to the high performance BGR circuit reported in literature [33], [34]. The BGR circuit achieved a 0.1%/V variation with power supply. The total power consumption of the BGR circuit was 132 nW.

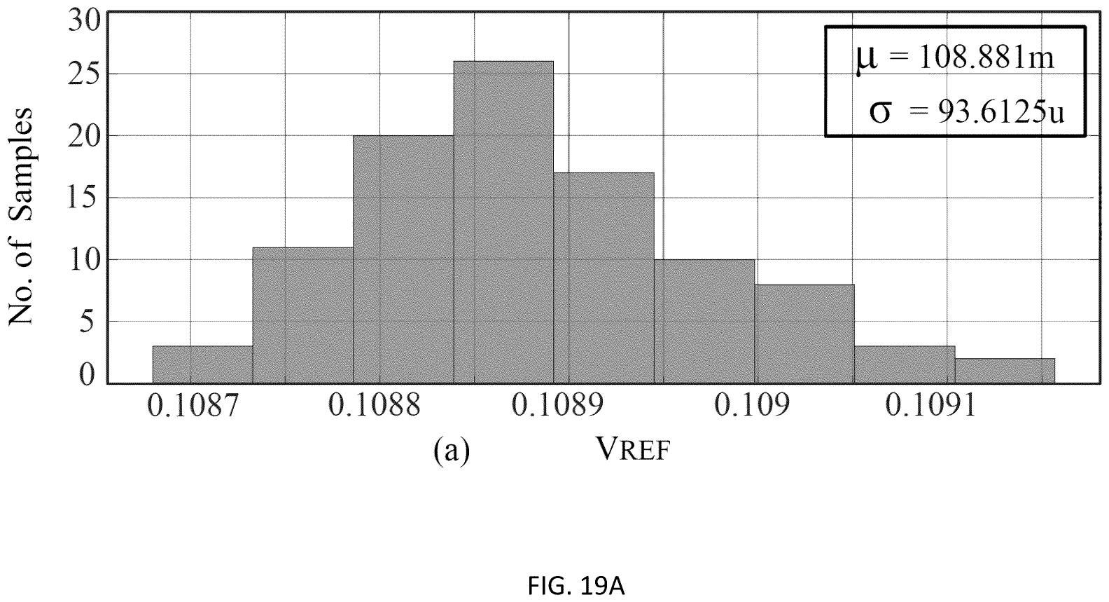

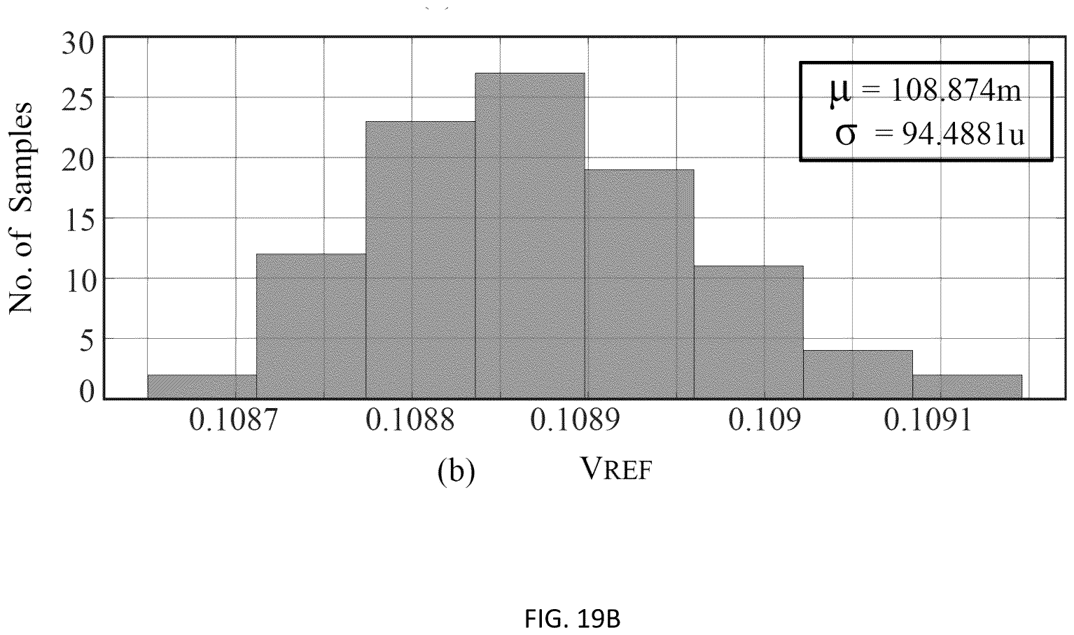

The performance of the BGR circuit was also compared both with a clock-based and key-based switched-cap network to quantify variation in circuit performance. Simulation results in FIG. 19 show the result of a 100-point Monte-Carlo simulation to assess the impact of process variation on V_{REF}. FIG. 19A shows the statistical variation of V_{REF} with a clock-based SC network BGR. It shows that V_{REF} has a μ of 108.881 mV with a σ of 93.6 μV. FIG. 19B shows the statistical variation of V_{REF} with a key-based SC BGR. Simulation results of key-based chopping in FIG. 19B show a μ of 108.874 mV and a σ of 94.5 μV. The simulation showed that the difference in mean V_{REF} value was less than 0.006%, which showed that there was no meaningful difference in the output among the two configurations discussed with reference to FIG. 19A and FIG. 19B.

### Analog Locking Techniques: Features and Performance Comparison

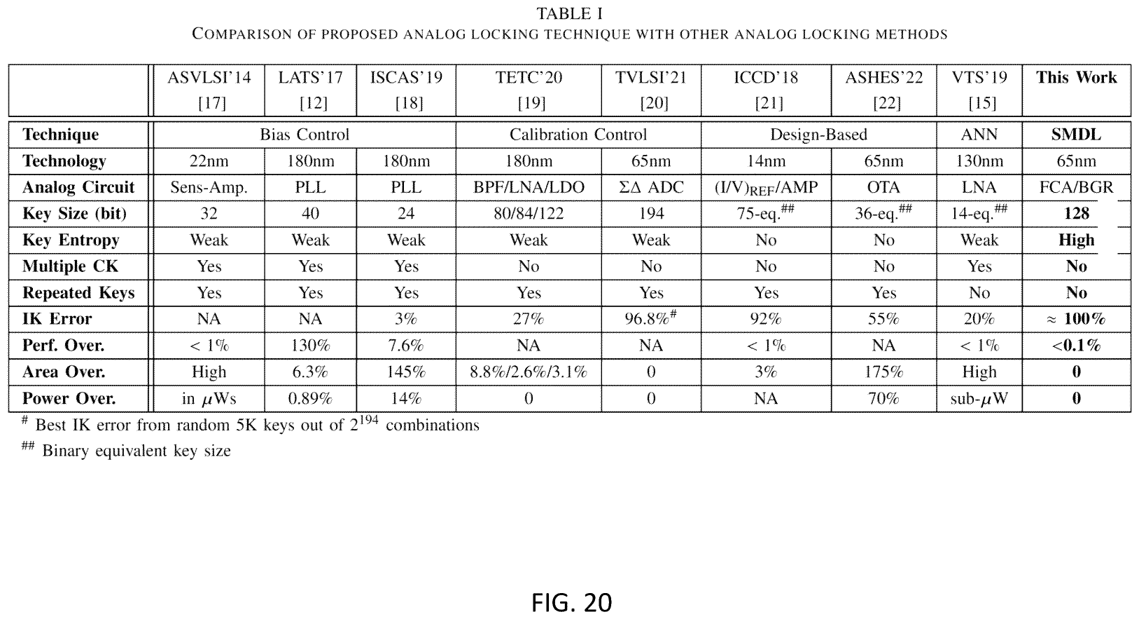

Table I in FIG. 20 shows a comparison of SMDL with other reported works in the literature across cryptographic properties such as key-size, key-entropy, IK error among others, along with circuit's performance, power, and area overhead.

Analog locking using voltage or current bias [12], [17], [18] can suffer from relatively small key sizes and can have multiple CKs. Errors in performance or functionality between an IK and CK can be as little as 3% [18]. Also, a similar bias configuration may be needed for different chips, leading to repeated correct keys for those chips. Such repeated correct keys may have lower key entropy and incur high performance, area, and power overhead. Similarly a calibration based locking method [19], [20] can also have low key entropy with repeated keys for multiple ICs. The least IK error may be 27% [19]. Design-based locking techniques [21], [22] can have one correct key per design leading to no key entropy. High IK error of 92% [21] can be achieved due to added design variation for a wrong transistor choice. However, this may incur large area and power overheads [22]. An ANN based approach may similarly suffer from a limited key space. In the ANN approach, IK can produce 20% error and design incurs high area overhead due to the ANN implementation.

As described herein, SMDL based FCA and BGR designs were implemented in a 65 nm CMOS process. FCA and BGR circuits were used as an example but these examples can easily be extended to a variety of analog circuits such as switched-capacitor filters, DC-DC converters, LDO, ADC, among others.

Further, the bias voltage using BGR and amplifier designs can be used inside a variety of analog circuits to provide multiple layers of protection. The designs were evaluated using a random key generator 128-bit key, which has high entropy. Because locking may be carried out in the time-domain, large key size such as 2K or 4K can easily be incorporated. Because a random key generator, which may be dependent on random variation, is used, multiple CK or repeated keys may not be anticipated. The switching technique may make analog circuit functionality dependent on transient alignment of the key, which locks circuit functionality. FIG. 8 and FIG. 13B show analog circuit operation with IK, where the analog circuit shows no meaningful operation. It yields almost 100% error with an IK. The locking technique incorporates locking in existing switch mode designs, where phases are varied based on the key. Because existing switching infrastructure is used, the locking technique design does not incur any significant area, power, or performance overheads. The additional digital circuit and key generator needed for the locking design may be what is needed for any locking technique. Thus, the analog circuit locking solution, as presented herein, may not add additional circuit components to the core analog circuit.

### Resilience Against Attacks

Resilience Against ThreatModels: SMDL, as described herein, can use a randomly generated key to lock analog circuits. The original manufacturer may maintain the correct key corresponding to each chip. It may be possible for an attacker to steal the chip to launch a piracy attack. However, the correct key to operate the chip may be maintained and supplied by the original manufacturer through their web-based user authentication system. The generated random key in a pirated design may not be available on the original manufacturer website, and thus the chip may not be authenticated. Similarly, a counterfeiting attack may also not be effective against the SDML scheme. Reverse engineering attacks, although more expensive, can be launched. However, the attacker may also need to come up with their own supply chain and key generator circuit to be effective. This would incur significant cost overhead for an attacker.

Resilience Against Unlocking Methods: A 128-bit key was implemented for locking analog circuits, with the locking design having flexibility to incorporate even higher key sizes. Such a long key may allow for analog circuits to be secure against a typical brute-force attack to unlock the design. In a removal or bypass attack [35], an attacker may remove the obfuscated design and replace it with an equivalent component. However, it may be a difficult attack to launch due to the involved design changes requiring expertise as well as cost to implement. Satisfiability checking (SAT) based attacks [36] may be used to unlock a locked analog circuit, particularly one requiring digital logic to implement the locking method. However, the locking scheme described herein (SMDL) may involve a clocking method and the analog circuit to implement the lock. As a result, the scheme described herein may show resilience against SAT attack.

A satisfiability modulo theory-based attack [37] and genetic algorithm attack [38] may be used to unlock analog circuits. These attacks can rely on the relationship between the obfuscated component and the key input. These attacks can utilize residual analog circuit functionality to hone in on the correct key. However, SMDL can completely obfuscate the analog circuit's functionality and any ability to discern useful analog functionality using optimization. An IK can produce almost 100% error in an analog circuit using SMDL, which can prevent search-based optimization. Large key size can further restrict the applicability of these attacks.

Side-channel attacks such as power analysis [39] can be attempted in order to break a key. However, compared to a digital design, analog based locking may show a lower power correlation. Because the power consumption of the analog circuit design may be low (e.g., the switched cap BGR circuit consumes a total of 132 nW), the resulting power variation may be low as well. This may further be assisted by the fact that these designs are current controlled where switched capacitor structure consumes the same power in both phases of the operation.

### CONCLUSION

A new method of locking analog circuits using SMDL technique is presented herein. To showcase its application, both an FCA and BGR circuit were developed using a conventional 65 nm CMOS process. Circuit parameters including transient output response, process variation, PSD, DFT, PSRR, reference voltage, and temperature variation for BGR and FCA chopper amplifier were presented. The locking method was characterized by a substantially long key size of 128 bits, a high entropy value of 0.9998, with an autocorrelation function value consistently ranging between −0.1 and 0.1, exhibited a high level of randomness and low predictability. Unlike other studies, the proposed scheme (SMDL) presented herein does not use multiple CKs or repeated keys, leading to unique operation per chip. SMDL can achieve an IK error of 100%, indicating total operational failure. The scheme can provide robust security for analog IPs to effectively safeguard against unauthorized access, piracy attacks, overproduction, and/or counterfeiting. The scheme may include insignificant performance, power, or area overhead.

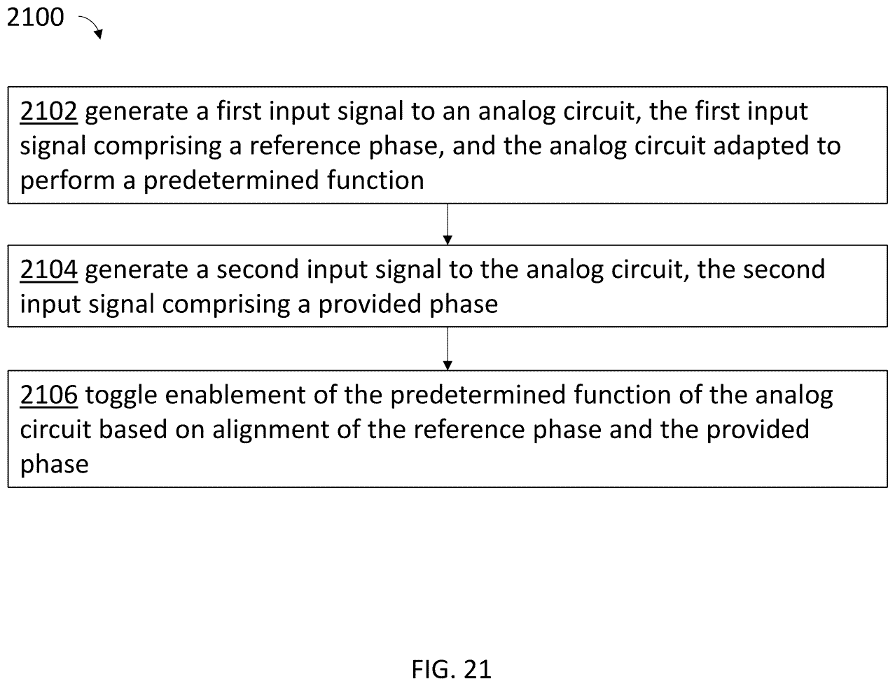

FIG. 21 is a flow chart depicting a method for obfuscating analog switched phase circuits according to various embodiments of the present disclosure. At 2102, a first input signal to an analog circuit may be generated. The first input signal comprises a reference phase. The analog circuit is adapted to perform a predetermined function. At 2104, a second input signal to the analog circuit may be generated. The second input signal comprises a provided phase. At 2106, enablement of the predetermined function of the analog circuit may be toggled based on alignment of the reference phase and the provided phase.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments. Additionally, elements and components described herein may be further divided into additional components or joined together to form fewer components for performing the same functions. Accordingly, the foregoing description and attached drawings are by way of example only, and are not intended to be limiting.

### REFERENCES

Each of the following references is hereby incorporated by reference in its entirety:
[1] M. Henriquez, “Winnti Apt Group stole trillions in intellectual property,” May 2022. [Online]. Available: www.securitymagazine.com/articles/97549-winnti-apt-group-stole-trillions-in-intellectual-property
[2] Guin, Ujjwal and Huang, Ke and DiMase, Daniel and Carulli, John M. and Tehranipoor, Mohammad and Makris, Yiorgos, “Counterfeit Integrated Circuits: A Rising Threat in the Global Semiconductor Supply Chain,” Proceedings of the IEEE, vol. 102, no. 8, pp. 1207-1228, 2014.
[3] Guin, Ujjwal and DiMase, Daniel and Tehranipoor, Mohammad, “Counterfeit Integrated Circuits: Detection, Avoidance, and the Chal-lenges Ahead,” Journal of Electronic Testing, vol. 30, no. 1, pp. 9-23, 2014. [Online]. Available: doi.org/10.1007/s10836-013-5430-8
[4] Yang, Tiancheng and Mittal, Ankit and Fei, Yunsi and Shrivastava, Aatmesh, “Large Delay Analog Trojans: A Silent Fabrication-Time Attack Exploiting Analog Modalities,” IEEE Transactions on Very Large Scale Integration (VLSI) Systems, vol. 29, no. 1, pp. 124-135, 2021.
[5] Bhasin, Shivam and Danger, Jean-Luc and Guilley, Sylvain and Ngo, Xuan Thuy and Sauvage, Laurent, “Hardware Trojan Horses in Crypto-graphic IP Cores,” in 2013 Workshop on Fault Diagnosis and Tolerance in Cryptography, 2013, pp. 15-29.
[6] Yang, Kaiyuan and Hicks, Matthew and Dong, Qing and Austin, Todd and Sylvester, Dennis, “A2: Analog Malicious Hardware,” in 2016 IEEE Symposium on Security and Privacy (SP), 2016, pp. 18-37.
[7] Rivest, R. L. and Shamir, A. and Adleman, L., “A Method for Obtaining Digital Signatures and Public-Key Cryptosystems,” Commun. ACM, vol. 21, no. 2, p. 120-126, feb 1978. [Online]. Available: doi.org/10.1145/359340.359342
[8] Zuzak, Michael and Liu, Yuntao and Srivastava, Ankur, “Trace Logic Locking: Improving the Parametric Space of Logic Locking,” IEEE Transactions on Computer-Aided Design of Integrated Circuits and Systems, vol. 40, no. 8, pp. 1531-1544, 2021.
[9] Yasin, Muhammad and Mazumdar, Bodhisatwa and Rajendran, Jeyavi-jayan J V and Sinanoglu, Ozgur, “SARLock: SAT attack resistant logic locking,” in 2016 IEEE International Symposium on Hardware Oriented Security and Trust (HOST), 2016, pp. 236-241.
[10] Yasin, Muhammad and Rajendran, Jeyavijayan J V and Sinanoglu, Ozgur and Karri, Ramesh, “On Improving the Security of Logic Locking,” IEEE Transactions on Computer-Aided Design of Integrated Circuits and Systems, vol. 35, no. 9, pp. 1411-1424, 2016.
[11] Zhang, Kevin, “1.1 Semiconductor Industry: Present & Future,” in 2024 IEEE International Solid-State Circuits Conference (ISSCC), vol. 67, 2024, pp. 10-15.
[12] Rao, Vaibhav Venugopal and Savidis, Ioannis, “Protecting analog cir-cuits with parameter biasing obfuscation,” in 2017 18th IEEE Latin American Test Symposium (LATS). IEEE, 2017, pp. 1-6.
[13] Rajendran, Jeyavijayan and Sinanoglu, Ozgur and Karri, Ramesh, “Is split manufacturing secure?” in 2013 Design, Automation & Test in Europe Conference & Exhibition (DATE), 2013, pp. 1259-1264.
[14] Rajendran, Jeyavijayan and Sam, Michael and Sinanoglu, Ozgur and Karri, Ramesh, “Security Analysis of Integrated Circuit Camouflaging,” in Proceedings of the 2013 ACM SIGSAC Conference on Computer & Communications Security, ser. CCS '13. New York, NY, USA: Association for Computing Machinery, 2013, p. 709-720. [Online]. Available: doi.org/10.1145/2508859.2516656
[15] Volanis, Georgios and Lu, Yichuan and Nimmalapudi, Sai Govinda Rao and Antonopoulos, Angelos and Marshall, Andrew and Makris, Yiorgos, “Analog performance locking through neural network-based biasing,” in 2019 IEEE 37th VLSI Test Symposium (VTS). IEEE, 2019, pp. 1-6.
[16] Wang, Jiafan and Shi, Congyin and Sanabria-Borbon, Adriana and Sa'nchez-Sinencio, Edgar and Hu, Jiang, “Thwarting analog ic piracy via combinational locking,” in 2017IEEE International Test Conference (ITC), 2017, pp. 1-10.
[17] Hoe, David H K and Rajendran, Jeyavijayan and Karri, Ramesh, “To-wards secure analog designs: A secure sense amplifier using memristors,” in 2014 IEEE Computer Society Annual Symposium on VLSI. IEEE, 2014, pp. 516-521.
[18] Rao, Vaibhav Venugopal and Savidis, Ioannis, “Mesh based obfuscation of analog circuit properties,” in 2019 IEEE International Symposium on Circuits and Systems (ISCAS). IEEE, 2019, pp. 1-5.
[19] Jayasankaran, N. G. and BO' rbon, A. Sanabria and SA' nchez-Sinencio, E. and Hu, J. and Rajendran, J., “Towards Provably-Secure Analog and Mixed-Signal Locking Against Overproduction,” IEEE Transactions on Emerging Topics in Computing, vol. 10, no. 1, pp. 386-403, 2022.
[20] Elshamy, Mohamed and Sayed, Alhassan and Loue\ddot{ } rat, Marie-Minerve and Aboushady, Hassan and Stratigopoulos, Haralampos-G., “Locking by Untuning: A Lock-Less Approach for Analog and Mixed-Signal IC Security,” IEEE Transactions on Very Large Scale Integration (VLSI) Systems, vol. 29, no. 12, pp. 2130-2142, 2021.
[21] Saki, Abdullah Ash- and Ghosh, Swaroop, “How Multi-Threshold Designs Can Protect Analog IPs,” in 2018 IEEE 36th International Conference on Computer Design (ICCD), 2018, pp. 464-471.
[22] Aljafar, Muayad J. and Aza\ddot{ } is, Florence and Flottes, Marie-Lise and Pagliarini, Samuel, “Leveraging Layout-based Effects for Locking Analog ICs,” in Proceedings of the 2022 Workshop on Attacks and Solutions in Hardware Security, ser. ASJHES'22. New York, NY, USA: Association for Computing Machinery, 2022, p. 5-13. [Online]. Available: doi.org/10.1145/3560834.3563826
[23] Mittal, Ankit and Mirchandani, Nikita and Michetti, Giuseppe and Colombo, Luca and Haque, Tanbir and Rinaldi, Matteo and Shrivastava, Aatmesh, “A ±0.5 dB, 6 nW RSSI Circuit With RF Power-to-Digital Conversion Technique for Ultra-Low Power IoT Radio Applications,” IEEE Transactions on Circuits and Systems I: Regular Papers, vol. 69, no. 9, pp. 3526-3539, 2022.
[24] Enz, C. C. and Temes, G. C., “Circuit techniques for reducing the effects of op-amp imperfections: autozeroing, correlated double sampling, and chopper stabilization,” Proceedings of the IEEE, vol. 84, no. 11, pp. 1584-1614, 1996.
[25] Shrivastava, Aatmesh and Craig, Kyle and Roberts, Nathan E. and Wentzloff, David D. and Calhoun, Benton H., “5.4 A 32 nW bandgap reference voltage operational from 0.5V supply for ultra-low power systems,” in 2015 IEEE International Solid-State Circuits Conference—(ISSCC) Digest of Technical Papers, 2015, pp. 1-3.
[26] D. Kinniment, O. Maevsky, A. Bystrov, G. Russell, and A. Yakovlev, “On-chip structures for timing measurement and test,” Microprocessors and Microsystems, vol. 27, no. 9, pp. 473-483, 2003. [Online]. Available: www.sciencedirect.com/science/article/pii/50141933103000966
[27] Ong, Eng-Jon and Bober, Miroslaw, “Improved Hamming Distance Search Using Variable Length Hashing,” in 2016 IEEE Conference on Computer Vision and Pattern Recognition (CVPR), 2016, pp. 2000-2008.
[28] U, Chi-Wa and Law, Man-Kay and Lam, Chi-Seng and Martins, Rui P., “Switched-Capacitor Bandgap Voltage Reference for IoT Applications,” IEEE Transactions on Circuits and Systems I: Regular Papers, vol. 69, no. 1, pp. 16-29, 2022.
[29] Mu, Junchao and Liu, Lianxi and Zhu, Zhangming and Yang, Yintang, “A 58-ppm/o C 40-nW BGR at Supply From 0.5 V for Energy Harvesting IoT Devices,” IEEE Transactions on Circuits and Systems II: Express Briefs, vol. 64, no. 7, pp. 752-756, 2017.
[30] Chi-Wa, U. and Zeng, Wen-Liang and Law, Man-Kay and Lam, Chi-Seng and Martins, Rui Paulo, “A 0.5-V Supply, 36 nW Bandgap Reference With 42 ppm/° C. Average Temperature Coefficient Within −40° C. to 120° C.,” IEEE Transactions on Circuits and Systems I: Regular Papers, vol. 67, no. 11, pp. 3656-3669, 2020.
[31] Liu, Lianxi and Mu, Junchao and Zhu, Zhangming, “A 0.55-V, 28-ppm/° C., 83-nW CMOS Sub-BGR With UltraLow Power Curvature Compensation,” IEEE Transactions on Circuits and Systems I: Regular Papers, vol. 65, no. 1, pp. 95-106, 2018.
[32] Mirchandani, Nikita and Shafiee, Nasim and Fei, Yunsi and Shrivastava, Aatmesh, “An Ultra-low Power and Lower Area Current-Mode based Physically Unclonable Function with less than 100 nW Power Consump-tion and a Native Instability of 0.6875
[33] Ueno, Ken and Hirose, Tetsuya and Asai, Tetsuya and Amemiya, Yoshihito, “A 300 nW, 15 ppm/° C., 20 ppm/V CMOS Voltage Reference Circuit Consisting of Subthreshold MOSFETs,” IEEE Journal of Solid-State Circuits, vol. 44, no. 7, pp. 2047-2054, 2009.
[34] Ivanov, Vadim and Brederlow, Ralf and Gerber, Johannes, “An Ultra Low Power Bandgap Operational at Supply From 0.75 V,” IEEE Journal of Solid-State Circuits, vol. 47, no. 7, pp. 1515-1523, 2012.
[35] Yasin, Muhammad and Mazumdar, Bodhisatwa and Sinanoglu, Ozgur and Rajendran, Jeyavijayan, “Removal Attacks on Logic Locking and Camouflaging Techniques,” IEEE Transactions on Emerging Topics in Computing, vol. 8, no. 2, pp. 517-532, 2020.
[36] Subramanyan, Pramod and Ray, Sayak and Malik, Sharad, “Evaluating the security of logic encryption algorithms,” in 2015 IEEE International Symposium on Hardware Oriented Security and Trust (HOST), 2015, pp. 137-143.
[37] Jayasankaran, Nithyashankari Gummidipoondi and Sanabria-Borbo'n, Adriana and Abuellil, Amr and Sa'nchez-Sinencio, Edgar and Hu, Jiang and Rajendran, Jeyavijayan, “Breaking Analog Locking Techniques,” IEEE Transactions on Very Large Scale Integration (VLSI) Systems, vol. 28, no. 10, pp. 2157-2170, 2020.
[38] Acharya, Rabin Yu and Chowdhury, Sreeja and Ganji, Fatemeh and Forte, Domenic, “Attack of the Genes: Finding Keys and Parameters of Locked Analog ICs Using Genetic Algorithm,” in 2020 IEEE International Symposium on Hardware Oriented Security and Trust (HOST), 2020, pp. 284-294.
[39] P. Kocher, J. Jaffe, and B. Jun, “Differential power analysis,” in Advances in Cryptology—CRYPTO' 99, M. Wiener, Ed. Berlin, Heidelberg: Springer Berlin Heidelberg, 1999, pp. 388-397.

What is claimed is:

1. A method for obfuscating analog switched phase circuits, the method comprising:
generating a first input signal to an analog circuit, the first input signal comprising a reference phase, the analog circuit adapted to perform a predetermined function;
generating a second input signal to the analog circuit, the second input signal comprising a provided phase; and
toggling enablement of the predetermined function of the analog circuit based on alignment of the reference phase and the provided phase.

2. The method of claim 1, wherein generating the first input signal comprises generating the first input signal by applying an output of a key space function to a clock signal.

3. The method of claim 2, wherein the key space function is a physically unclonable function (PUF).

4. The method of claim 2, wherein the output of the key space function is a first key.

5. The method of claim 2, wherein the first input signal is output from a shift register adapted to receive the clock signal and the output of the key space function.

6. The method of claim 1, wherein generating the second input signal comprises generating the second input signal by applying a second key to a clock signal.

7. The method of claim 6, wherein the second input signal is output from a shift register adapted to receive the clock signal and the second key.

8. The method of claim 6, wherein the second key is a user input key.

9. The method of claim 1, wherein toggling the enablement of the predetermined function of the analog circuit comprises disabling the predetermined function of the analog circuit when the reference phase and the provided phase are misaligned.

10. The method of claim 9, wherein disabling the predetermined function comprises producing a short-circuit or an open-circuit in the analog circuit.

11. The method of claim 10, further comprising:
sensing the short-circuit or the open-circuit in the analog circuit; and
determining an occurrence of an adversarial attack based on the short-circuit or the open-circuit.

12. The method of claim 1, wherein toggling the enablement of the predetermined function of the analog circuit comprises enabling the predetermined function of the analog circuit when the reference phase and the provided phase are aligned.

13. A system for obfuscating analog switched phase circuits, the system comprising:
key space function circuit adapted to generate a first key;
a key loading unit adapted to receive a second key;
a first shift register adapted to:
receive a clock signal,
receive the first key from the key space function circuit, and
apply the first key to the clock signal to generate a first input signal to an analog circuit, the first input signal comprising a reference phase, and the analog circuit adapted to perform a predetermined function; and
a second shift register adapted to:
receive the clock signal,
receive the second key from the key loading unit, and
apply the second key to the clock signal generate a second input signal to the analog circuit, the second input signal comprising a provided phase;
wherein enablement of the predetermined function of the analog circuit is toggled based on alignment of the reference phase and the provided phase.

14. The system of claim 13, wherein the key space function circuit is a physically unclonable function (PUF) circuit.

15. The system of claim 13, wherein the second key is a user input key.

16. The system of claim 13, wherein the predetermined function of the analog circuit is disabled when the reference phase and the provided phase are misaligned.

17. The system of claim 16, wherein the predetermined function of the analog circuit is disabled by producing a short-circuit or an open-circuit in the analog circuit.

18. The system of claim 17, further comprising sensor circuitry adapted to:
sense the short-circuit or the open-circuit in the analog circuit; and
determine an occurrence of an adversarial attack based on the short-circuit or the open-circuit.

19. The system of claim 13, wherein the predetermined function of the analog circuit is enabled when the reference phase and the provided phase are aligned.

20. The system of claim 13, wherein the analog circuit comprises a chopping amplifier, a switched-capacitor voltage regulator, a bandgap voltage reference circuit, or a DC-DC converter.
